(19) United States
(12) Patent Application Publication
(10) Pub. No.: US 2026/0313393 A1
(43) Pub. Date: Oct. 8, 2026

(54) MACHINE LEARNING-BASED ANALYTICS AT NETWORK LAYERS

(71) Applicant: Telefonaktiebolaget LM Ericsson (publ), Stockholm (SE)

(72) Inventors: Aurelie Boisbunon, Massy (FR); Illyyne Saffar, Le plessis-Robinson (FR); Amin Azari, Järfälla (SE); Abdulrahman Alabbasi, Kista (SE); Tao Cui, Sollentuna (SE)

(21) Appl. No.: 19/481,713

(22) PCT Filed: May 8, 2023
(86) PCT No.: PCT/EP2023/062097

§ 371 Date: Nov. 5, 2025

(51) Int. Cl. H04W 24/02; G06N 20/00; H04W 48/20

(52) U.S. Cl. CPC H04W 24/02; G06N 20/00; H04W 48/20

(57) ABSTRACT

Embodiments of the present disclosure provide machine learning-based analytics at network layers. The method comprises: receiving, from a first network layer, a first latent representation of first information available at the first network layer, the first latent representation being extracted by a trained first machine learning model executed at the first network layer, the first machine learning model being configured to generate a first predicted output for a first analytic task based on the first information; generating, at a second network layer and using a trained second machine learning model, a second predicted output for a second analytic task based on the first latent representation and second information available at the second network layer, the second network layer being different from the first network layer; and determining, at the second network layer, a target output for the second analytic task based on the second predicted output.

### FIELD

Embodiments of the present disclosure generally relate to the field of telecommunication and in particular, to machine learning (ML)-based analytics at network layers.

### BACKGROUND

Wireless communication systems are widely deployed to provide various telecommunication services such as telephony, video, data, messaging, and broadcasts. In the telecommunication industry, artificial intelligence/machine learning (AI/ML) models have been employed in communication systems to improve the performance. In typical communication architectures, various analytic tasks are defined at different network protocol layers, such as serving cell selection/scheduling, radio resource allocation/scheduling, packet generation/processing, and the like. As a specific example, a serving cell selection function aims at selecting a serving cell (e.g., a primary cell, and/or secondary cells) to add into a set of serving cell lists of a terminal device. As used herein, a primary cell (pCell) refers to a cell operating on a primary band of a terminal device and handling Radio Resource Control (RRC) connection of the terminal device, a secondary cell (sCell) refers to a cell aggregating with the pCell and providing additional resources to the terminal device configured with carrier aggregation (CA). All of the cells to be aggregated for a terminal device are referred to as serving cells for the terminal device.

It is proposed to adopt a machine learning model to learn more knowledge about serving cell (e.g., cell coverage) in order to select the best serving cells for the terminal device. In such solutions, by analyzing some measurements and applying machine learning techniques, prediction of cell coverage is provided for serving cell selection. Machine learning models typically rely on relevant information to output correct prediction. In the example of serving cell selection, a straightforward solution is to collect all the relevant information across network protocol layers at the serving cell selection function in which the machine learning model is deployed. However, this may lead to expensive introduction of message exchanges between layers for information exchange, the load of such data transfer on the system, and also the latency of analytics. Other AI-based analytic tasks may be confronted with similar challenges when models deployed at a network layer requires relevant information available at the other network layer.

### SUMMARY

Embodiments of the present disclosure provide an improved solution for machine learning-based analytics, to optimize the analytics with simplified message exchanges, reduced load for cross-layer information exchange, and lowered latency of decision making.

Specifically, the embodiments of the present disclosure propose to extract knowledge from available information at a first network layer and transfer the knowledge to a second different network layer for use, in order to improve the analytics implemented at the second network layer. The transfer of knowledge is achieved through a first trained machine learning model at the first network layer, a second trained machine learning model at the second network layer and a knowledge transfer module therebetween. The first trained machine learning model at the first network layer extracts a latent representation of information available at this layer, which is transferred to the second network layer for use in combination with information available at the second network layer by the second machine learning model. As such, outputs for the analytic task implemented at the second network layer can be enhanced with knowledge from the other network layer. In addition, as the extracted latent representation instead of the raw data are exchanged cross layers, the amount of exchanged information is reduced or minimized.

In a first aspect of the present disclosure, a method implemented by a network device is proposed. The method comprises: receiving, from a first network layer, a first latent representation of first information available at the first network layer, the first latent representation being extracted by a trained first machine learning model executed at the first network layer, the first machine learning model being configured to generate a first predicted output for a first analytic task based on the first information; generating, at a second network layer and using a trained second machine learning model, a second predicted output for a second analytic task based on the first latent representation and second information available at the second network layer, the second network layer being different from the first network layer; and determining, at the second network layer, a target output for the second analytic task based on the second predicted output, wherein the first predicted output indicates whether at least one serving cell is to be scheduled for a terminal device, the second predicted output indicates whether the at least one serving cell is to be selected as a potential serving cell for the terminal device, and the target output indicates a subset of serving cells selected from a set of available serving cells for the terminal device, or wherein the first predicted output indicates resource allocation to at least one terminal device located in a network slice, the second predicted output indicates potential resource allocation to a traffic flow in the network slice, and the target output indicates target resource allocation to the traffic flow in the network slice

In some embodiments of the first aspect, the first latent representation is input together with the second information into the second machine learning model. In some embodiments of the first aspect, the first latent representation is processed together with a second latent representation of the second information by the second machine learning model to generate the second predicted output.

In some embodiments of the first aspect, the first analytic task is based on an output of the second analytic task, the method further comprising: generating, at the second network layer, a third predicted output for the second analytic task based on third information available at the second network layer. In some embodiments of the first aspect, the first machine learning model is configured to generate the first predicted output for the first analytic task based on the first information and the third predicted output.

In some embodiments of the first aspect, the first network layer comprises a lower protocol layer, and the second network layer comprises a higher protocol layer. In some embodiments of the first aspect, the first information comprises first measurement information related to the at least one serving cell at the lower protocol layer, and the second information comprises second measurement information related to the at least one serving cell at the higher protocol layer.

In some embodiments of the first aspect, the first machine learning model is trained for a first serving cell, and the first latent representation is specific to the first serving cell, the method further comprising: in accordance with a determination that measurement information related to a second serving cell is unavailable, mapping, at the higher protocol layer, the first latent representation of the first measurement information related to the first serving cell to a third latent representation for the second serving cell; or receiving, at the higher protocol layer, the third latent representation for the second serving cell from the lower protocol layer.

In some embodiments of the first aspect, the second predicted output is generated further based on the third latent representation, to further indicate whether the second serving cell is to be selected as a potential serving cell for the terminal device.

In some embodiments of the first aspect, the first network layer comprises a real time layer in an open radio access network (O-RAN), and the second network layer comprises a non-real time layer or a near real time layer in the O-RAN. In some embodiments of the first aspect, the first network layer comprises a near-real time layer in the O-RAN, and the second network layer comprises a non-real time layer in the O-RAN.

In some embodiments of the first aspect, the second predicted output is provided as a recommendation for determining the target output, or is determined as the target output.

In a second aspect of the present disclosure, a method for training machine learning models to be executed by a network device is proposed. The method comprises: training a first machine learning model using first information available at a first network layer as a model input and a first ground truth output for the first information in a first analytic task; extracting, using the trained first machine learning model, a first latent representation of the first information; training a second machine learning model using second information available at a second network layer, the first latent representation, and a second ground truth output for the second information in a second analytic task; and providing the trained first machine learning model and the trained second machine learning model for execution by the network device, wherein the first ground truth output indicates whether at least one serving cell is to be scheduled for a terminal device, and the second ground truth output indicates whether the at least one serving cell is to be selected as a potential serving cell for the terminal device, or wherein the first ground truth output indicates resource allocation to at least one terminal device located in a network slice, and the second ground truth output indicates potential resource allocation to a traffic flow in the network slice.

In some embodiments of the second aspect, the first latent representation is input together with the second information into the second machine learning model. In some embodiments of the second aspect, the first latent representation is processed together with a second latent representation of the second information by the second machine learning model to generate a model output.

In some embodiments of the second aspect, the method further comprises: before the training of the first machine learning model, performing initial training of the second machine learning model using at least third information available at the second network layer. In some embodiments of the second aspect, the second machine learning model is retrained using the second information, the first latent representation, and the second ground truth output.

In some embodiments of the second aspect, the first network layer comprises a lower protocol layer, and the second network layer comprises a higher protocol layer. In some embodiments of the second aspect, the first information comprises first measurement information related to the at least one serving cell at the lower protocol layer, and the second information comprises second measurement information related to the at least one serving cell at the higher protocol layer.

In some embodiments of the second aspect, the first ground truth output is retrieved from a serving cell scheduler at the lower protocol layer and indicates whether the at least one serving cell is to be scheduled for the terminal device. In some embodiments of the second aspect, the second ground truth output is retrieved from a serving cell selection function at the higher protocol layer and indicates whether the at least one serving cell is to be selected as a potential serving cell for the terminal device.

In some embodiments of the second aspect, the first ground truth output indicates whether the at least one serving cell is to be scheduled for the terminal device at respective time instances within a period of time, the method further comprising: aggregating the first ground truth output and the second ground truth output to obtain an aggregated ground truth output indicating whether the at least one serving cell is to be selected as a potential serving cell for the terminal device within the period of time. In some embodiments of the second aspect, the second machine learning model is trained using the aggregated ground truth output.

In some embodiments of the second aspect, the first machine learning model is trained for a first serving cell, and the first latent representation is specific to the first serving cell, the method further comprising: in accordance with a determination that measurement information related to a second serving cell is unavailable, mapping the first latent representation of the first measurement information related to the first serving cell to a third latent representation for the second serving cell. In some embodiments of the second aspect, the second machine learning model is trained further using the third latent representation.

In some embodiments of the second aspect, the first network layer comprises a real time layer in an open radio access network (O-RAN), and the second network layer comprises a non-real time layer or a near real time layer in the O-RAN. In some embodiments of the second aspect, the first network layer comprises a near-real time layer in the O-RAN, and the second network layer comprises a non-real time layer in the O-RAN.

In a third aspect, a network device is proposed. The network device comprises: at least one processor; and at least one memory coupled to the at least one processor, the at least one memory comprising instructions that when executed by the at least one processor implement a method comprising: receiving, from a first network layer, a first latent representation of first information available at the first network layer, the first latent representation being extracted by a trained first machine learning model executed at the first network layer, the first machine learning model being configured to generate a first predicted output for a first analytic task based on the first information; generating, at a second network layer and using a trained second machine learning model, a second predicted output for a second analytic task based on the first latent representation and second information available at the second network layer, the second network layer being different from the first network layer; and determining, at the second network layer, a target output for the second analytic task based on the second predicted output, wherein the first predicted output indicates whether at least one serving cell is to be scheduled for a terminal device, the second predicted output indicates whether the at least one serving cell is to be selected as a potential serving cell for the terminal device, and the target output indicates a subset of serving cells selected from a set of available serving cells for the terminal device, or wherein the first predicted output indicates resource allocation to at least one terminal device located in a network slice, the second predicted output indicates potential resource allocation to a traffic flow in the network slice, and the target output indicates target resource allocation to the traffic flow in the network slice.

In a fourth aspect, a computing system is proposed. The computing system comprises: at least one processor; and at least one memory coupled to the at least one processor, the at least one memory comprising instructions that when executed by the at least one processor implement a method for training machine learning models to be executed by a network device. The method comprises: training a first machine learning model using first information available at a first network layer as a model input and a first ground truth output for the first information in a first analytic task; extracting, using the trained first machine learning model, a first latent representation of the first information; training a second machine learning model using second information available at a second network layer, the first latent representation, and a second ground truth output for the second information in a second analytic task; and providing the trained first machine learning model and the trained second machine learning model for execution by the network device, wherein the first ground truth output indicates whether at least one serving cell is to be scheduled for a terminal device, and the second ground truth output indicates whether the at least one serving cell is to be selected as a potential serving cell for the terminal device, or wherein the first ground truth output indicates resource allocation to at least one terminal device located in a network slice, and the second ground truth output indicates potential resource allocation to a traffic flow in the network slice.

In a fifth aspect, an apparatus is proposed. The apparatus comprises means for receiving, from a first network layer, a first latent representation of first information available at the first network layer, the first latent representation being extracted by a trained first machine learning model executed at the first network layer, the first machine learning model being configured to generate a first predicted output for a first analytic task based on the first information; means for generating, at a second network layer and using a trained second machine learning model, a second predicted output for a second analytic task based on the first latent representation and second information available at the second network layer, the second network layer being different from the first network layer; and means for determining, at the second network layer, a target output for the second analytic task based on the second predicted output, wherein the first predicted output indicates whether at least one serving cell is to be scheduled for a terminal device, the second predicted output indicates whether the at least one serving cell is to be selected as a potential serving cell for the terminal device, and the target output indicates a subset of serving cells selected from a set of available serving cells for the terminal device, or wherein the first predicted output indicates resource allocation to at least one terminal device located in a network slice, the second predicted output indicates potential resource allocation to a traffic flow in the network slice, and the target output indicates target resource allocation to the traffic flow in the network slice.

In a sixth aspect, an apparatus is proposed. The apparatus comprises means for training a first machine learning model using first information available at a first network layer as a model input and a first ground truth output for the first information in a first analytic task; means for extracting, using the trained first machine learning model, a first latent representation of the first information; means for training a second machine learning model using second information available at a second network layer, the first latent representation, and a second ground truth output for the second information in a second analytic task; and means for providing the trained first machine learning model and the trained second machine learning model for execution by the network device, wherein the first ground truth output indicates whether at least one serving cell is to be scheduled for a terminal device, and the second ground truth output indicates whether the at least one serving cell is to be selected as a potential serving cell for the terminal device, or wherein the first ground truth output indicates resource allocation to at least one terminal device located in a network slice, and the second ground truth output indicates potential resource allocation to a traffic flow in the network slice.

In a seventh aspect, a computer readable medium is proposed. The computer readable medium has instructions stored thereon, the instructions when executed by at least one processor causing the at least one processor to perform the method according to any of the embodiments of the first aspect.

In an eighth aspect, a computer readable medium is proposed. The computer readable medium has instructions stored thereon, the instructions when executed by at least one processor causing the at least one processor to perform the method according to any of the embodiments of the second aspect.

In a ninth aspect, a computer program is proposed. The computer program comprises instructions which, when executed on at least one processor, cause the at least one processor to carry out the method according to any of the embodiments of the first aspect.

In a tenth aspect, a computer program is proposed. The computer program comprises instructions which, when executed on at least one processor, cause the at least one processor to carry out the method according to any of the embodiments of the second aspect.

The embodiments of the present disclosure enable machine learning-based network analytics with cross-layer knowledge transfer. In this solution, knowledge is extracted from available information at one network layer and transferred to another network layer for use, in order to improve the analytics implemented at the other network layer. Outputs for the analytic task implemented at one network layer can be enhanced with knowledge from the other network layer. In addition, as the extracted latent representation instead of the raw data are exchanged cross layers, the amount of exchanged information is reduced or minimized. Therefore, the machine learning-based analytics can be optimized with simplified message exchanges, reduced load for cross-layer information exchange, and lowered latency of decision making.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, where:

FIG. 1 illustrates a schematic diagram of a simplified architecture for analytics at network layers in which embodiments of the present disclosure may be applied;

FIG. 2 illustrates a schematic diagram of a radio access network (RAN) where serving cell selection may be implemented;

FIG. 3A illustrates a schematic diagram of a radio protocol stack in accordance with some embodiments of the present disclosure;

FIG. 3B illustrates a schematic diagram of action spaces for serving cells at different layers in accordance with some embodiments of the present disclosure;

FIG. 4 illustrates a schematic diagram of an open-radio access network (O-RAN) architecture where resource allocation may be implemented;

FIG. 5 illustrates a schematic diagram of an architecture for machine learning-based analytics at network layers with cross-layer knowledge transfer in accordance with some embodiments of the present disclosure;

FIG. 6 illustrates a schematic diagram of a training flow for the machine learning models with knowledge transfer in accordance with some embodiments of the present disclosure;

FIG. 7 illustrates a schematic diagram showing example integrations of the latent representation from a machine learning model with another machine learning model in accordance with some embodiments of the present disclosure;

FIG. 8A to FIG. 8D illustrate schematic diagrams of different training stages for the machine learning models with knowledge transfer in accordance with some embodiments of the present disclosure;

FIG. 9 illustrates a schematic diagram showing domain adaptation between pre-selected cells and non-selected cells in accordance with some embodiments of the present disclosure;

FIG. 10 illustrates a signaling chart for training of machine learning models with knowledge transfer in accordance with some further embodiments of the present disclosure;

FIG. 11A and FIG. 11B illustrate schematic diagrams of inference of machine learning models with knowledge transfer in accordance with some further embodiments of the present disclosure;

FIG. 12 illustrates a flowchart of a method implemented at a network device in accordance with some embodiments of the present disclosure;

FIG. 13 illustrates a flowchart of a method for model training in accordance with some embodiments of the present disclosure;

FIG. 14 illustrates a simplified block diagram of a network device that is suitable for implementing embodiments of the present disclosure; and

FIG. 15 illustrates a simplified block diagram of a virtual environment that is suitable for implementing model training in accordance with some embodiments of the present disclosure.

Throughout the drawings, the same or similar reference numerals represent the same or similar element.

### DETAILED DESCRIPTION

Some of the embodiments contemplated herein will now be described more fully with reference to the accompanying drawings. The embodiments set forth below represent information to enable those skilled in the art to practice the embodiments and illustrate the best mode of practicing the embodiments. Upon reading the following description in light of the accompanying figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

As used herein, the term “includes” and its variants are to be read as open terms that mean “includes, but is not limited to.” The term “based on” is to be read as “at least in part based on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

As used herein, the term “network node” may also be referred to as a network function (NF), a network entity, or a network device, and refers to a physical, virtual or hybrid function or entity which is deployed at a network side and provides one or more services to clients/consumers. For example, an NF may be arranged at a device in a radio access network (RAN) or a core network (CN) of a communication system. The network node may be implemented in hardware, software, firmware, or some combination thereof. Examples of a network node in a RAN include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like. Examples of a network node in a CN include, but not limited to, a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communications in a communication environment may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the fourth generation (4G), 4.5G, the fifth generation (5G) communication protocols, 5.5G, 5G-Advanced networks, or the sixth generation (6G) networks and beyond and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As used herein, the term “model” is referred to as an association between an input and an output learned from training data, and thus a corresponding output may be generated for a given input after the training. The generation of the model may be based on machine learning (ML) techniques. The machine learning techniques may also be referred to as artificial intelligence (AI) techniques. In general, a machine learning model can be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein.

Generally, machine learning may usually involve three stages, i.e., a training stage, a validation stage, and an application stage (also referred to as an inference stage). At the training stage, a given machine learning model may be trained (or optimized) iteratively using a great amount of training data until the model can obtain, from the training data, consistent inference similar to those that human intelligence can make. During the training, a set of parameter values of the model is iteratively updated until a training objective is reached. Through the training process, the machine learning model may be regarded as being capable of learning the association between the input and the output (also referred to an input-output mapping) from the training data. At the validation stage, a validation input is applied to the trained machine learning model to test whether the model can provide a correct output, so as to determine the performance of the model. Generally, the validation stage may be considered as a step in a training process, or sometimes may be omitted. At the inference stage, the trained machine learning model may be used to process a real-world model input based on the set of parameter values obtained from the training process and to determine the corresponding model output.

### Example Environment

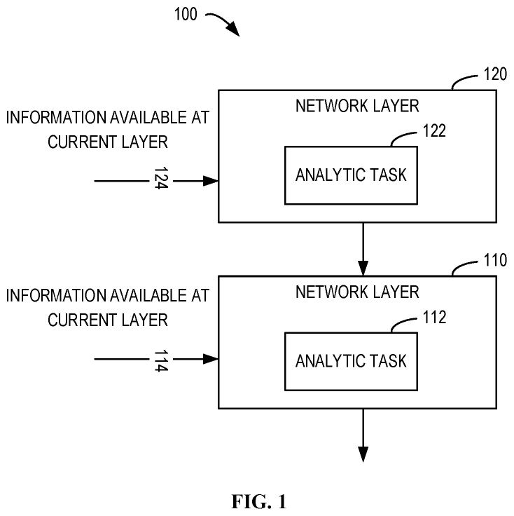

In typical communication architectures, various analytic tasks are defined at different network protocol layers, such as serving cell selection/scheduling, radio resource allocation/scheduling, packet generation/processing, and the like. FIG. 1 illustrates a schematic diagram of a simplified architecture 100 for analytics at network layers in which embodiments of the present disclosure may be applied. As shown, at a network layer 110 (which is sometimes referred to as a first network layer herein), an analytic task 112 (which is sometimes referred to as a first analytic task herein) is performed with information 114 available at the network layer 110. At a network layer 120 (which is sometimes referred to as a second network layer herein), an analytic task 122 (which is sometimes referred to as a second analytic task herein) is performed with information 124 available at this layer. The network layers 110 and 120 are different layers defined for a network device(s) in a communication network. Information can be exchanged between the network layers 110 and 120 via specified interfaces and according to specified messages formats. The analytic tasks may be any prediction/analysis tasks that are to be performed within a communication environment. In some embodiments, an output of an analytic task at a network layer may be used as an input or part of the input to the analytic task at the other network layer.

Different network layers may be defined in different communication networks. In a radio access network (RAN), a radio protocol stack is defined with three network layers, Layer 1, Layer 2, and Layer 3. An analytic task of serving cell selection for a terminal device may be implemented at Layer 3 at a network device in the RAN.

An open-RAN (O-RAN) architecture aims at intelligent RAN automation by applying artificial intelligence, machine learning, and advanced analytics to manage complex, ever changing network, device and end-user requirements for optimal efficiency. In an O-RAN, there may be two or more network layers, including a non-real time (non-RT) layer (also referred to as a service management and orchestration (SMO) layer), a near real time (near-RT) layer, and/or a real time (RT) layer which implements control and optimization of RAN elements and resources. An example analytic task in the O-RAN may include resource allocation at the network layers.

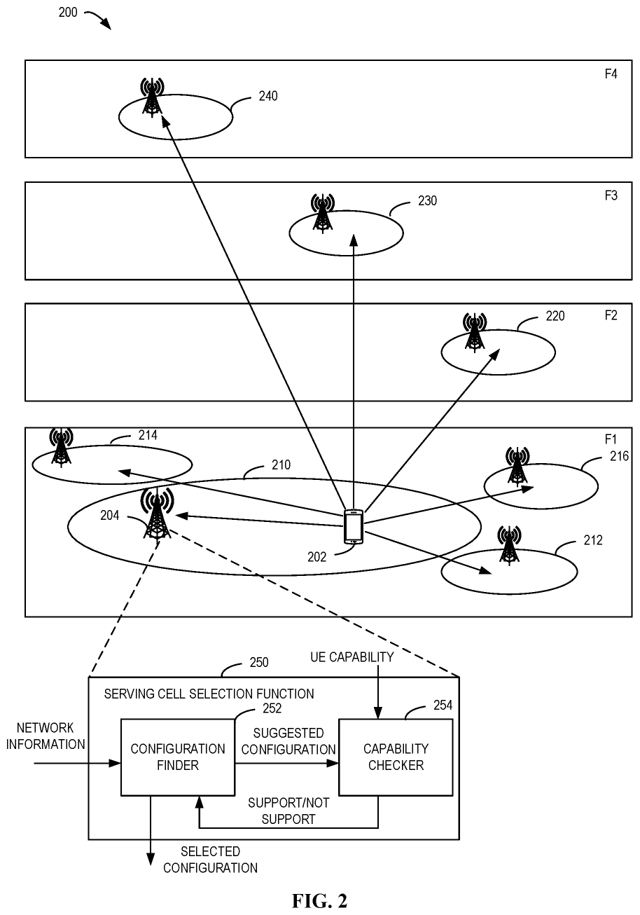

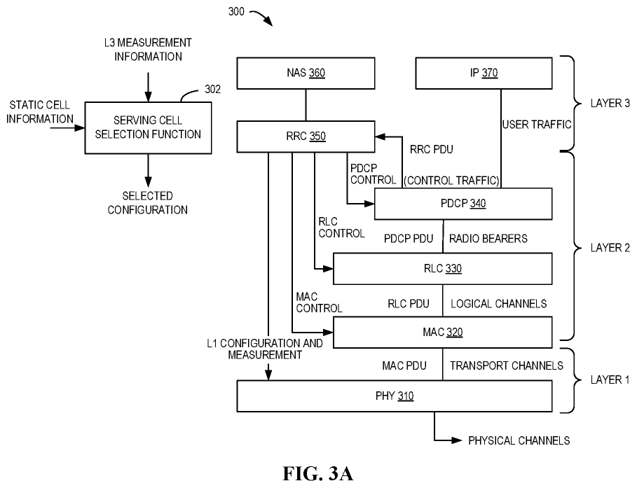

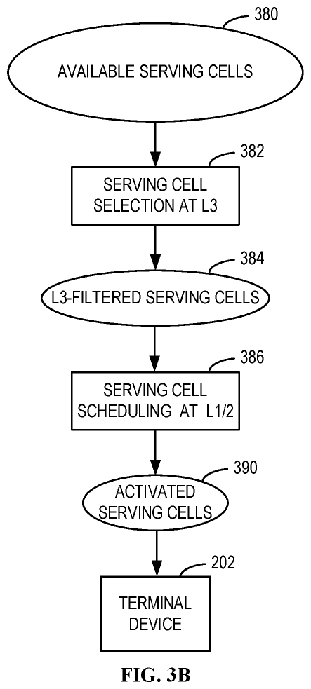

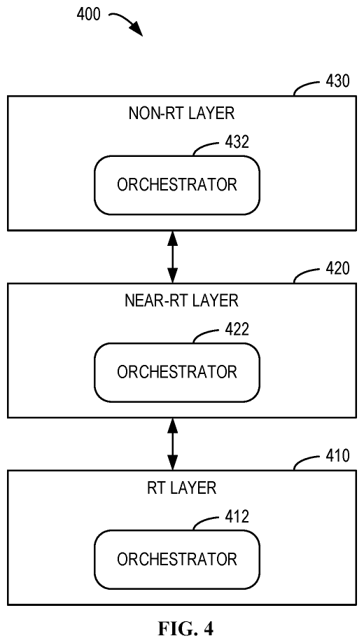

To better understand the analytics scenarios in the communication networks, references will be made to FIG. 2, FIGS. 3A-3B, and FIG. 4 to illustrate the serving cell selection task and the resource allocation task in the O-RAN.

It is also to be understood that the elements shown in the figures are intended to represent main functions provided within the environment. As such, the blocks shown in the following figures refer to specific elements in communication networks that provide these main functions. However, other network elements may be used to implement some or all of the main functions represented. Also, it is to be understood that not all functions of a communication environment are depicted in the figures. Rather, functions that facilitate an explanation of illustrative embodiments are represented.

Serving cell selection is supported when carrier aggregation (CA) is introduced in communication systems. Using carrier aggregation, multiple component carriers (CCs) can be aggregated and jointly used for transmission to or from a single wireless device. FIG. 2 illustrates a schematic diagram of a RAN 200 where serving cell selection may be implemented. In this example, there are four carriers/bands F1, F2, F3, and F4. Cells 210, 212, 214, and 216 operate at F1, a cell 220 operates at F2, a cell 230 operates at F3, and a cell 240 operates at F4. With respect to a particular terminal device 202, the cell 210 serves as a primary cell (pCell) of the terminal device 202, where the pCell handles Radio Resource Control (RRC) connection. Other cells to be aggregated with the pCell for the terminal device 202 are referred to as secondary cells (sCells). All of the cells to be aggregated for the terminal device 202 are referred to as serving cells for the terminal device 202.

In the shown example, it is assumed that the four carriers/bands F1, F2, F3, and F4 are all available at the location of the terminal device 202, one in which the pCell is located (also referred to as a serving carrier), and three neighbor carriers/bands. Furthermore, there are three neighbor cells available at the serving carrier of the terminal device 202, and three sCells on the neighbor carriers/bands.

Using CA, secondary cells can be added to the primary cell to increase the bandwidth, and thereby increase the bitrate. Introduction of CA in communication networks has introduced a set of new functionalities, as follows.

An sCell may be added, released, or reconfigured for a terminal device. The sCell addition, release, and reconfiguration are responsibility of the RRC layer. RRC may configure sCells for CA-capable terminal devices. The initial Scell configuration can be blind in the sense that it is based on network knowledge of configuration. Then the measurements are configured on the sCell carrier frequency as well as other frequencies in order to understand all the frequencies where the terminal device has coverage. Once an sCell is added to the set of serving cells (which may include a pCell and one or more sCells), the terminal device can perform measurements on the sCell (and on all the serving cells) without a need for measurement gaps. The network device (e.g., the network device 204 in the pCell 210) always tries to configure the terminal device 202 with best cell (radio conditions) as sCell, in order to increase the spectrum efficiency.

After configuring an sCell as a serving cell for the terminal device 202, in order for the terminal device 202 to receive data on the sCell, it has to be activated which is next step after configuring the sCell. This activation is done via a media access control (MAC) control element. To enable reasonable battery consumption by the terminal device 202 when CA is configured, an activation/deactivation mechanism of sCells is supported. If the terminal device 202 is configured with one or more sCells, the network device 204 may activate and deactivate the configured sCells.

In some embodiments, the network device 204 may deactivate an sCell when there is no more data to be delivered to the terminal device 202 or the channel quality of the sCell turns to be bad. In some embodiments, an sCell is removed from pCell or from a set of serving cells through a RRC connection reconfiguration procedure.

The network device 204 may include a serving cell selection function 250 which aims at selecting best serving cell to add to a set of serving cell lists by optimizing the configuration of the terminal device 202 based on the UE supported band combinations to be matched with the carrier aggregation configurations supported in the RAN 200. As shown, the serving cell selection function 250 may comprise two functions for capability checking during the serving cell selection procedure, a configuration finder 252 and a capability checker 254.

The configuration finder 252 may collect network information which indicates supported carrier aggregation configurations and resources in the RAN 200. The configuration finder 252 may suggest a configuration to be checked by the capability checker 254. The suggested configuration may indicate one or more serving cells to be configured for the terminal device 202. The capability checker 254 also receives UE capability of the terminal device 202 and checks whether the suggested configuration is supported by the terminal device 202 based on the capability of the terminal device 202. The output of the capability checker 254 indicates whether the suggested configuration is supported by the terminal device 202 and is provided as a feedback to the configuration finder 252. This process continues until all configurations are checked or timeout. The configuration finder 252 may output a selected configuration that is supported by the terminal device 202. If the serving cell selection procedure is unable to find a configuration that is supported by the capabilities of the terminal device 202, a UE capability failure is declared and a capability failure trigger is performed.

FIG. 3A illustrates a schematic diagram of a radio protocol stack 300 in accordance with some embodiments of the present disclosure. The radio protocol stack for the terminal device and the network device is shown with three layers: Layer 1, Layer 2, and Layer 3. Layer 1 (L1 layer) is the lowest layer. The physical (PHY) layer 310 at the L1 layer provides an information transfer service on physical channels. Sometimes the L1 layer will be referred to as the physical layer. Layer 2 (L2 layer) is above the physical layer 310 and is responsible for the link between the terminal device and the network device over the physical layer 310.

The L2 layer includes a media access control (MAC) layer 320, a radio link control (RLC) layer 330, and a packet data convergence protocol (PDCP) 340 layer. Layer 3 (L3 layer) includes a radio resource control (RRC) layer 350, a non-access stratum (NAS) layer 360, and an Internet protocol (IP) layer 370.

The PHY layer 310 provides an information transfer service to its higher layer on physical channels. As shown, the PHY layer 310 is connected to the MAC layer 320 through transport channels and data is packaged as MAC packet data unit (PDU) and transferred between the MAC layer 320 and the PHY layer 310 on the transport channels. The MAC layer 320 is connected to the RLC layer 330 through logical channels and data is packaged as RLC PDU and transferred between the RLC layer 330 and the MAC layer 320 on the logical channels. The RLC layer 330 is connected to the PDCP layer 340 which provides multiplexing between different radio bearers and logical channels. Data is transferred between the PDCP layer 340 and the RLC layer 330 as PDCP PDU. User traffic is transferred between the IP layer 370 and the PDCP layer 340.

The RRC layer 350 is responsible for obtaining radio resources (e.g., radio bearers) and for configuring the lower layers using RRC signaling. The RRC layer 350 provides PDCP control signaling to the PDCP layer 340 and receives control traffic as RRC PDU from the PDCP layer 340. The RRC layer 350 also provides RLC control signaling to the RLC layer 330, MAC control signaling to the MAC layer 320, and LI configuration and measurement to the PHY layer 310.

FIG. 3B illustrates a schematic diagram of action spaces for serving cells at different protocol layers in accordance with some embodiments of the present disclosure. With respect to a specific terminal device, e.g., the terminal device 202 in FIG. 2, there will be a set of available serving cells 380 which may include one pCell and one or more sCells. Serving cell selection 382 is performed at the L3 layer, to select a subset of serving cells from the set of available serving cells, which is referred to as L3-filtered serving cells 384. Then serving cell scheduling 386 is performed at the L1/2 layer, to schedule one or more serving cells (the pCell and one or more sCells) for the terminal device 202. The serving cell(s) to be scheduled are activated serving cells 390 for the terminal device 202.

### Use Cases of Cross-Layer Information Exchange

For the serving cell selection, some solutions aim at maximizing the achievable downlink (DL) and uplink (UL) data rates based on static cell information and L3 measurement information from the L3 layer, e.g., the network configuration and UE configuration, the cell bandwidth (BW), the used TDD pattern, the number of MIMO layers and the like. As shown in FIG. 3A, a serving cell selection function 302 receives static cell information and L3 measurement information from the L3 layer to determine a selected configuration of serving cells for a terminal device.

However, with only the L3 measurement information, there may be many important information missed from the serving cell selection procedure. For example, there is no consideration of coverage of the sCell at the location of the terminal device and load of the sCell, which may rely on information from lower layers, i.e., the L1 and/or L2 layers. Hence, the initial sCell selection is done blindly, i.e., no sCell coverage information is known by the network device prior to the sCell configuration. Only after the selected configuration, based on the information (available through measurement reports) from the terminal device, the network device can change the sCell configuration to a possible better one, especially if A6-based reselection is triggered. Such blind selection approach leads to the situations that data transfer happens on the pCell only because sCell(s) are not ready to take traffic. The main reason behind taking this approach is the need for low-latency decision making. In other words, most of data communications sessions are short in time and this time duration is always decreasing due to the increase in system capacity. Hence, if one tries to find an optimal sCell, there is a risk of losing the time at which sCell is needed (for some systems, it is expected that 80% of traffic is handled by the pCell, and 20% of traffic is handled by the sCells).

In this case, there is a need for interfaces and message exchanges between the L1/2 layers and the L3 layer, which on the other hand introduces extra overhead, complexity and requires extra storage at the hardware.

Recently, ML-powered serving cell selection approaches have been proposed that aim at improving the process of carrier aggregation configuration by adopting a machine learning model to the serving cell selection process. For example, the machine learning model may be configured to predict sCell coverage within the pCell. In such solutions, by analyzing some measurements and applying machine learning techniques, prediction of sCell coverage based on estimation of the radio location of the terminal device within the pCell is provided. Towards this end, a straightforward solution is to get all the related information across layers at the serving cell selection function in which a machine learning model is deployed to learn from the data and make decisions accordingly. One drawback with this solution is the expensive introduction of message exchanges between layers for information exchange, and also the load of such data transfer on the system. When compared against the potential benefit in performance improvement, this solution lacks technoeconomic feasibility.

A solution in the Patent Application US2019357057A1 has proposed building machine learning models at the L3 layer from background L3 measurements. Based on this solution, sCell coverage knowledge may be built using periodic report strongest cells (RSCs) measurements triggered by a network device on inactive terminal devices (terminal devices which are connected to the network device but do not have any data transmission) configured to measure sCell frequencies that are configured on the network device. However, this solution requires assistant terminal devices (i.e., inactive terminal devices), which may cause energy consumption and side effect for the assistant terminal devices. Sometimes there may be lack of neighbors, for example, when a serving cell has too strong signal channel quality than the other cells. There is also a need for additional configurations and measurements to the system. In other words, the model does not leverage the plenty of available data in RAN, but instead, requests for additional measurements. On the other hand, the period at which the learnt models have valid outputs depends on the quality of training, which itself is dependent upon having neighbors for data collection. The gathered data and the model are specific to a pCell-sCell relation, i.e., they are lost at removal or change of cell relation or cell lock, resulting in limited reusability of machine learning models and gathered data.

Another solution in the Patent Application US2020106536A1 has proposed to use UE-related measurements taken on a PCell in a wireless communication system in a machine learning model, for example, a neural network outside of the RAN network device. Using this machine learning algorithm and pCell measurements, prediction of achievable channel quality for each of the sCells are derived. These predicted achievable channel qualities are then sent back to the sCell selection function for decision making. That is, the machine learning models are built to transform pCell channel measurements into sCell coverage predictions. However, the pCell frequency is usually sub-GHz, and pCell channel measurements and overlapped sCells are expected to be lossy coupled, especially for higher values of sCell carrier frequencies. Specially at higher frequencies, even orientation of the device and movement of blockers affects the channel state significantly. The main use-case of this solution could be indoor dense radio access networks.

A further solution in the Patent Application US9467918B1 has proposed an out-of-RAN machine learning agent for load prediction of cells. The output of this prediction may be fed into the mobility management function as an extra and dynamic input. Some similar works propose enhancement on this solution by applying a reinforcement learning algorithm for the implementation out of RAN which aims at balancing loads between different RATs by prediction of load of them. However, while providing load information for the serving cell selection function can bring value to the key performance indicators (KPIs) of interest, especially in terms of throughput, the channel state information to the sCells is the main remaining challenge to be solved. This is due to the fact that the lack of coverage at the UE position by the configured sCell can result in excessive measurements, and hence, wastage of energy and delay in communication.

Some other solutions in the Patent Applications US2021007023A1, WO2021107831A1, and WO2022084469A1 have proposed to apply UE-side information and collaboration for mobility management. Based on these solutions, a terminal device leverages its information from its sensors, to have a rough estimate of its location in the cell. Such location indication could be shared with the RAN, or further processing on that input could be done in the UE side, and the output be sent back to the RAN for decision making on mobility management and serving cell selection. However, exposure of information from UE-side to the network side opens up doors to enabling a bunch of interesting functionalities, among them, optimization of communications parameters like discontinuous reception (DRX) and configuration of the set of serving cells are of great interest. However, such solutions need to tackle privacy issues in sharing information by the device, e.g., location of UE and require memory, processing, and energy consumption at the UE side, which may be unacceptable for certain devices or users.

It has been discussed above the machine learning-based serving cell selection in RAN and some legacy solutions proposed for this function. To sum up, in order to optimize the serving cell selection results, more information are needed, which may cause increased load of data transfers across network layers, or latency, complexity and/or security issues if out-of-RAN information or UE-side information are introduced.

In addition to the serving cell selection function in RAN, machine learning-based analytics is also applicable in other communication systems. FIG. 4 illustrates a schematic diagram of an O-RAN 400 architecture where an analytic task of resource allocation may be implemented. O-RAN aims at intelligent RAN automation by applying artificial intelligence, machine learning, and advanced analytics to manage complex, ever-changing network, device and end-user requirements for optimal efficiency.

The O-RAN architecture 400 may include two or more network layers, a RT layer 410, a near-RT layer 420, and a non-RT layer 430. In some implementations, the O-RAN architecture 400 may include two layers, for example, the near-RT layer 420 and the non-RT layer 430, the near-RT layer 420 and the RT layer 410, or the non-RT layer 430 and the RT layer 410. As shown, the layers 410, 420, and 430 includes orchestrators 412, 422, 432, respectively, to controls radio resource management (RRM) in RAN. An orchestrator may also be referred to as a RAN intelligence controller (RIC).

The orchestrator 432 at the non-RT layer 430 enables non-real-time control and optimization of RAN elements and network resources. The orchestrator 422 at the near-RT layer 420 enables near-real-time control and optimization of RAN elements and network resources. The orchestrator 412 at the RT layer 410 enables real-time control and optimization of RAN elements and network resources. For example, in the case of network slicing, the allocation of resources to a traffic flow over a network slice is implemented in near-real time at the near-RT layer 420 or even non-real time at the non-RT layer 430 by using a machine learning model. Scheduling of the resources to terminal devices in that network slice is implemented in real time at the RT layer 410 or in near-real time at the near-real time at the near-RT layer 420 by using a machine learning model.

Conventionally, the orchestrator at each layer utilizes information available at that layer to perform the analytics task (e.g., resource allocation to a network slice, or resource scheduling to terminal devices). Information from the other layer(s) may certainly optimize the analytics at the higher network layer, for example, to predict more reasonable resource allocation to a network slice according to the existing terminal devices within that network slice. The information exchange between network layers may lead to expensive introduction of message exchanges, the load of such data transfer on the system, and also the latency of analytics, which is undesirable.

### Work Principle and Overall Architecture

Example embodiments of the present disclosure provide an improved solution for machine learning-based network analytics with cross-layer knowledge transfer. In this solution, knowledge is extracted from available information at a first network layer and transferred to a second different network layer for use, in order to improve the analytics implemented at the second network layer. The transfer of knowledge is achieved through a first trained machine learning model at the first network layer, a second trained machine learning model at the second network layer and a knowledge transfer module therebetween. The first trained machine learning model at the first network layer extracts a latent representation of information available at this layer, which is transferred to the second network layer for use in combination with information available at the second network layer by the second machine learning model. As such, outputs for the analytic task implemented at the second network layer can be enhanced with knowledge from the other network layer. In addition, as the extracted latent representation instead of the raw data are exchanged cross layers, the amount of exchanged information is reduced or minimized. Therefore, the machine learning-based analytics at the second network layer can be optimized with simplified message exchanges, reduced load for cross-layer information exchange, and lowered latency of decision making.

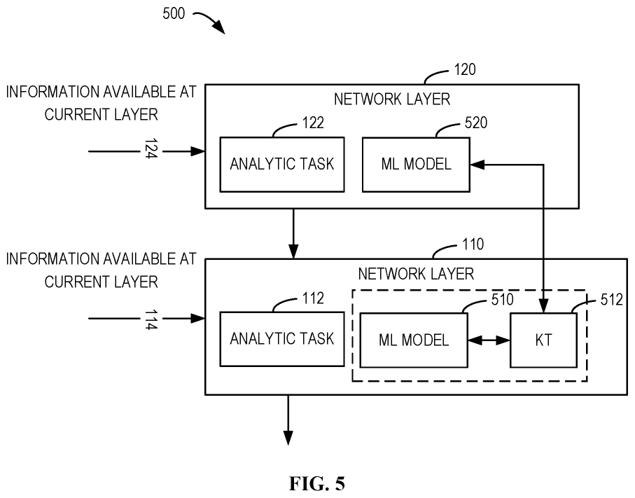

FIG. 5 illustrates a schematic diagram of an architecture 500 for machine learning-based analytics at network layers with cross-layer knowledge transfer in accordance with some embodiments of the present disclosure. The architecture 500 is based on the simplified architecture 100 for analytics at network layers as illustrated in FIG. 1. In addition to the elements shown in the architecture 100 of FIG. 1, the architecture 500 further includes a machine learning model 510 (which is sometimes referred to as a first machine learning model herein) and a knowledge transfer (KT) function 512 at the network layer 110, and a machine learning model 520 (which is sometimes referred to as a second machine learning model herein) at the network layer 120.

The machine learning model 510 is used to extract and compress knowledge from information that is available at the network layer 110 and relevant to the analytic task 122 at the network layer 120. The KT function 512 is used to transfer the knowledge from the network layer 110 to the network layer 120. With the transferred knowledge, the machine learning model 520 from the network layer 120 is aware about the information at the network layer 110 and can optimize the decision making for the analytic task 122 at the network layer 120. The machine learning model 510 may be implemented as an agent deployed at the network layer 110, and the KT function 512 may also be implemented as a KT agent deployed at the network layer 110. The machine learning model 520 may be implemented as an agent deployed at the network layer 120.

Specifically, the machine learning model 510 is executed at the network layer 110 to perform the analytic task 112. A model input to the machine learning model 510 includes the information 114 used for the analytic task 112, which is available at the network layer 110. A model output generated by the machine learning model 510 is a predicted output for the analytic task 112. During the task execution process, the machine learning model 510 extracts a latent representation from the input information 114 and transfers the latent representation to the network layer 120 via the KT function 512. The latent representation may be considered as a compressed version of the information 114, which may also be referred to as a feature representation, an embedding, or a feature of the information 114.

The machine learning model 520 is executed at the network layer 120 to perform the analytic task 112. The machine learning model 520 generates a predicted output for the analytic task 112 based on the latent representation from the network layer 110 and the information 124 available at the network layer 120. With the introduction of the latent representation, the feature space at the network layer 120 may be enriched, and more accurate predications can be achieved by the machine learning model 520. The predicted output from the machine learning model 520 is used to determine a target output for the analytic task 122. In some embodiments, the predicted output of the machine learning model 520 may be provided as a recommendation for determining the target output, or may be directly determined as the target output.

In the architecture 500, the machine learning model 510 acts as a knowledge synthesizer for the network layer 110, which aims at mimicking the behavior of the network layer 110 in the analytic task 112 and allows summarizing the information in this network layer into a compressed form. The machine learning model 520 is used to leverage the knowledge extracted from the machine learning model 510 for superior decision making. The KT function 512 may perform low-overhead cross-layer signaling between the two machine learning models at the two network layers. The machine learning models 510 and 520 may be constructed as any machine learning or deep learning models (e.g., neural networks) that are suitable for performing the analytic tasks 112 and 122, respectively and the specific model structures are not limited in the scope of the present disclosure.

In some embodiments, in the scenario of RAN 200, the analytic task 122 is a serving cell selection task, and the analytic task 112 is a serving cell scheduling task, both of which are performed at a network device, e.g., the network device 204. The predicted output from the machine learning model 520 indicates whether at least one serving cell is to be selected as a potential serving cell for a terminal device (e.g., the terminal device 202). The predicted output from the machine learning model 510 indicates whether the at least one serving cell is to be scheduled and activated for the terminal device 202. That is, the machine learning model 510 and the machine learning model 520 are used to make decisions for at least one serving cell for a certain terminal device. The target output indicates a subset of serving cells selected from a set of available serving cells for the terminal device 202, where the set of available serving cells include the at least one serving cell measured by the two models 510 and 520. In some embodiments, in the RAN 200, the network layer 120 may include a higher protocol layer, such as the L3 layer, and the network layer 110 may include a lower protocol layer, such as the L1 layer and/or the L2 layer.

In the embodiments of serving cell selection, the machine learning model 510 executed at the lower protocol layer (e.g., the L1 layer and/or the L2 layer) may receive measurement information related to the at least one serving cell, such as reference signal received power (RSRP) of the at least one serving cell, reference signal received quality (RSRQ) of the at least one serving cell, load of the at least one serving cell, and the like. The machine learning model 510 infers from the available information a latent representation for transferring to the machine learning model 520. The machine learning model 520 can combine the latent representation with measurement information related to the at least one serving cell that is available at the higher protocol layer, the L3 layer. The measurement information may include, for example, the network configuration, UE capabilities, and the like, in order to improve the serving cell selection mechanism at the L3 layer.

In some embodiments, the predicted output from the machine learning model 520 may be provided as a recommendation to the serving cell selection function 250 in the network device 204, to assist that function in making a decision about serving cells selected for the terminal device 202. In this case, the serving cell selection function 250 may receive the predicted output from the machine learning model 520 and determine the target output based on the received predicted output. Alternatively, in some embodiments, the machine learning model 520 may be deployed as a serving cell selection function in the network device 204, and thus the predicted output from the machine learning model 520 may be directly provided as a decision about serving cells selected for the terminal device 202.

Through the knowledge transfer, it can take advantages of both the legacy serving cell selection mechanism at the L3 layer as well as the legacy L1/2 scheduler by utilizing machine learning techniques. The transfer of information and knowledge learned from the L1/2 machine learning model to the L3 machine learning model can improve the serving cell selection and make the L3 layer more aware of the measurements and decision taken in the lower layers.

The proposed functions in FIG. 5 can also be applied for other cross-layer functions other than the serving cell selection. In some embodiments, in the scenario of O-RAN 400, the analytic task 122 is a slice resource allocation task, to allocate network resources to a traffic flow in a network slice. The analytic task 112 is a device resource allocation task, to allocate network resources to one or more terminal devices in that network slice. The predicted output from the machine learning model 520 indicates potential resource allocation to a traffic flow in the network slice. The predicted output from the machine learning model 510 indicates resource allocation to at least one terminal device located in a network slice. The target output indicates target resource allocation to the traffic flow in the network slice. In some embodiments, in the O-RAN 400, the network layer 120 may include the near-RT layer 420 or the non-RT layer 430, and the network layer 110 may include the RT layer 410. In some embodiments, in the O-RAN 400, the network layer 120 may include the non-RT layer 430, and the network layer 110 may include the near-RT layer 420. This depends on the actual network layer structure in the O-RAN.

In the embodiments of resource allocation, the machine learning model 510 may receive information related to the terminal devices in the network slice that is available the RT layer 410 (or the near-RT layer 420). The machine learning model 510 infers from the information a latent representation for transferring to the machine learning model 520. The machine learning model 520 can combine the latent representation with information related to the traffic flow and the network slice that is available at the near-RT layer 420 (or the non-RT layer 430), to derive more accurate decisions about resource allocation to the traffic flow in the network slice.

In some embodiments, the predicted output from the machine learning model 520 may be provided as a recommendation to the orchestrator 422 at the near-RT layer 420 (or to the orchestrator 432 at the non-RT layer 430), to assist that orchestrator in resource allocation. Alternatively, in some embodiments, the machine learning model 520 may be deployed as a resource allocation function in the orchestrator 422 at the near-RT layer 420 (or to the orchestrator 432 at the non-RT layer 430), and thus the predicted output from the machine learning model 520 may be directly provided as a decision about the resource allocation.

According to the embodiments of the present disclosure, the machine learning-based analytic task at the network layer 120 (for example, the serving cell selection or the slice resource allocation) can be optimized and enhanced with the cross-layer knowledge transfer from the other network layer, thereby lowering the latency in decision making. These benefits are achieved via learning the analytic task executed at the network layer 110 (for example, L1/L2 serving cell scheduling, or device resource allocation at the RT or near-RT). That is, the analytics at the network layer 120 is suited to the analytics at the network layer 110. Further, as the learnt knowledge or more specifically, the latent representation is transferred instead of raw information, the amount of exchanged information is reduced or minimized. In some embodiments, the machine learning models can be trained and executed in parallel without the need to change existing functions for the analytic tasks in the network layers, and thus can be easily compatible with the existing functions.

To leverage the machine learning model 510 and the machine learning model 520 for inference, a model training phase is first needed. The trained machine learning model 510 and the trained machine learning model 520 are provided for use in a model inference phase. In the following, the model training phase is first discussed, and then the model inference phase.

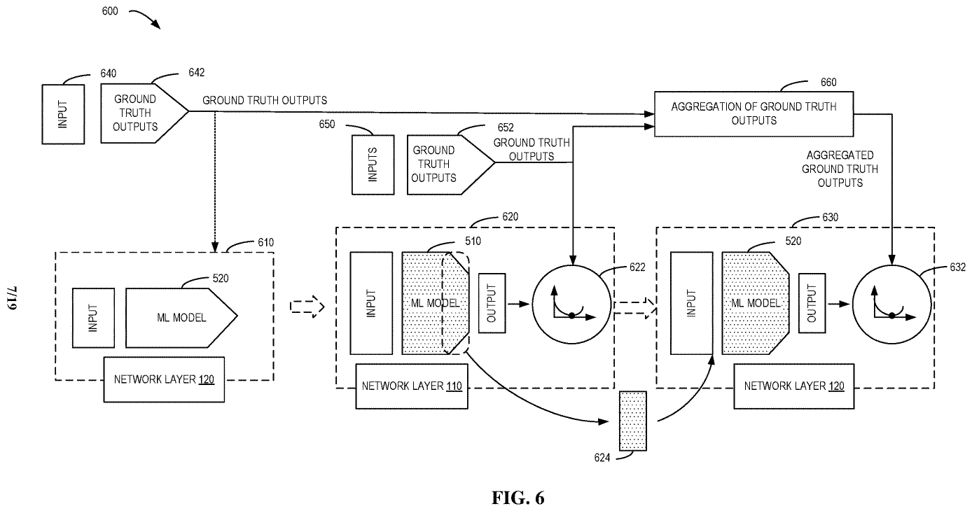

FIG. 6 illustrates a schematic diagram of a training flow 600 for the machine learning models with knowledge transfer in accordance with some embodiments of the present disclosure. In some embodiments, the training flow 600 may be implemented at a separate computing system which can access training data of the two models. This computing system may be a physical system or a virtualization system, which may be located in the communication network or external to the communication network where the trained machine learning models are deployed. In some embodiments, the training flow 600 may be implemented at a network device which executes the machine learning models.

The training data for the machine learning model 510 may include sample model inputs 650 to this model and respective ground truth outputs 652 as labels for the sample inputs. A sample model input may be information available at the network layer 110, and a ground truth output may be a ground truth output for the information in the analytic task 112. The training data for the machine learning model 520 may include sample model inputs 640 to this model and respective ground truth outputs 642 as labels for the sample inputs. A sample model input may be information available at the network layer 120, and a ground truth output may be a ground truth output for the information in the analytic task 122. The sample inputs and ground truth outputs for the machine learning model 510 may be collected at the network layer 110, and the sample inputs and ground truth outputs for the machine learning model 520 may be collected at the network layer 120.

In the context of serving cell selection, a ground truth output 652 indicates whether at least one serving cell is to be scheduled for a terminal device, and a ground truth output 642 indicates whether the at least one serving cell is to be selected as a potential serving cell for the terminal device. In the context of resource allocation, a ground truth output 652 indicates resource allocation to at least one terminal device located in a network slice, and a ground truth output 642 indicates potential resource allocation to a traffic flow in the network slice.

In some embodiments, the analytic task 112 is related to the analytic task 122, for example, based on an output of the analytic task 122. In this case, at the model training phase, an initialization step is needed before the training of the machine learning model 510. As shown in FIG. 6, an initial training stage 610 of the machine learning model 520 may be performed before training of the machine learning model 510. During the initial training stage 610, the machine learning model 520 may be trained using supervised, semi-supervised, or unsupervised learning algorithms. In the case of unsupervised learning algorithm is used, the model inputs (i.e., the information 640) are used but the ground truth outputs 642 may not be needed. Through the unsupervised learning, the machine learning model 520 may be trained to generate output clusters, and some domain knowledge of expert (e.g., prior knowledge) may be applied to assign each class or label to one of the clusters). In the case of the semi-supervised learning algorithm is used, some but not all of ground truth outputs (labels) are needed. In the case of the supervised learning algorithm is used, both the model inputs 640 and the ground truth outputs 642 are needed.

At a training stage 620, the machine learning model 510 is trained using information available at the network layer 110 as model inputs 650 and respective ground truth outputs 652 for the model inputs 650. During the training stage 620, the machine learning model 510 may be trained using the supervised learning algorithm. A model input 650 is input to the machine learning model 510 under training to provide a predicted output. An error between the predicted output and a ground truth output 652 of this model input 650 is determined. A training objective 622 of the machine learning model 510 is to reduce or minimize the error between the predicted outputs and the ground truth outputs by iteratively updating the model parameters of the machine learning model 510. Various training algorithms may be applied to achieve the training objective.

In some embodiments, if the analytic task 112 is related to the analytic task 122 based on an output of the analytic task 122, then the initially trained machine learning model 510 may be applied to perform the analytic task 122 first so as to provide outputs to the network layer 110 to implement the analytic task 112. At this time, the implementation of the analytic task 112 may be completed through legacy functions at the network layer 110, to generate the ground truth outputs for the machine learning model 510. In the context of serving cell selection, the ground truth output 652 may be retrieved from a serving cell scheduler at the L1 or L2 layer to indicate whether at least one serving cell is to be scheduled for a terminal device. In the context of resource allocation, the ground truth output 652 may be retrieved from the orchestrator 412 in the RT layer 410 (if the device resource allocation task is implemented at this layer) or the orchestrator 422 in the near-RT layer 420 (if the device resource allocation task is implemented at this layer), to indicate resource allocation to at least one terminal device located in a network slice.

At a training stage 630, the machine learning model 520 may be trained at least using information available at the network layer 120 as the model inputs 640 and the respective ground truth outputs 642 for the model inputs 640. In the case that the machine learning model 520 is initially trained at the stage 610, the machine learning model 520 may be further retrained at the stage 630. During the training stage 630, the machine learning model 520 may be trained using the supervised learning algorithm. A model input 640 is input to the machine learning model 520 under training to provide a predicted output. An error between the predicted output and a ground truth output 642 of this model input 640 is determined. A training objective 632 of the machine learning model 520 is to reduce or minimize the error between the predicted outputs and the ground truth outputs by iteratively updating the model parameters of the machine learning model 520. Various training algorithms may be applied to achieve the training objective.

It is expected that the ground truth outputs 642 are expected to indicate the actual optimized serving cells to be selected or the actual optimized resource allocation to a network slice, which may sometimes not be known in advance. In some embodiments, in the context of serving cell selection, the ground truth outputs 642 may be retrieved from a serving cell selection function at the L3 layer to indicate whether at least one serving cell is to be selected as a potential serving cell for the terminal device. In the context of resource allocation, the ground truth outputs 642 may be retrieved from the orchestrator 432 in the RT layer 430 (if the slice resource allocation task is implemented at this layer) or the orchestrator 422 in the near-RT layer 420 (if the slice resource allocation task is implemented at this layer), to indicate resource allocation to the terminal devices located in a network slice. The serving cell selection function may be first built according to strategies based on expert knowledge.

However, from a machine learning point of view, retraining a model with more data with a suboptimal ground truth can be penalizing for the machine learning model algorithm predicting the optimal outputs. Thus, in some embodiments, an unsupervised or semi-supervised algorithm may be applied to train the machine learning model 520 to relabel the ground truth outputs 642. In some embodiments, the ground truth outputs 642 may be aggregated with the ground truth outputs 652 in order to enhance the output labeling. The ground truth aggregation will be described in detail below.

As mentioned above, a latent representation 624 of a model input (information) of the machine learning model 510 will be transferred to the machine learning model 520 at the network layer 120. In some embodiments, the latent representation 624 may be extracted from a last layer before the output of the machine learning model 510.

Specifically, for a same analytic target in the analytic task 112 and the analytic task 122 (for example, the at least one serving cell in the context of serving cell selection, or the network slice in the context of resource allocation), the latent representation 624 of the input information related to the same analytic target is extracted using the trained machine learning model 510 and provided for training of the machine learning model 520. At the training stage 630, the machine learning model 520 may be trained using the input 640 (i.e., the information available at the network layer 120), the latent representation 624, and the ground truth output 642. It is noted that the latent representation 624 associated with the same analytic target is used in conjunction with the corresponding input 640.

The embodiments of the present disclosure aim to transfer a representation of the information available at the network layer 110 (e.g., L1/2 layer) for the analytic task at the network layer 120. The idea here is to train the machine learning model 510 that mimics the analytics mechanism at the network layer 110, and then transfer one or more layers before the output from this trained machine learning model 510 to the network layer 120. The transferred knowledge is denoted as a latent representation. This allows the machine learning model 520 to be more aware of the decisions made on the network layer 110 which knows a synthesized version of the information at that layer.

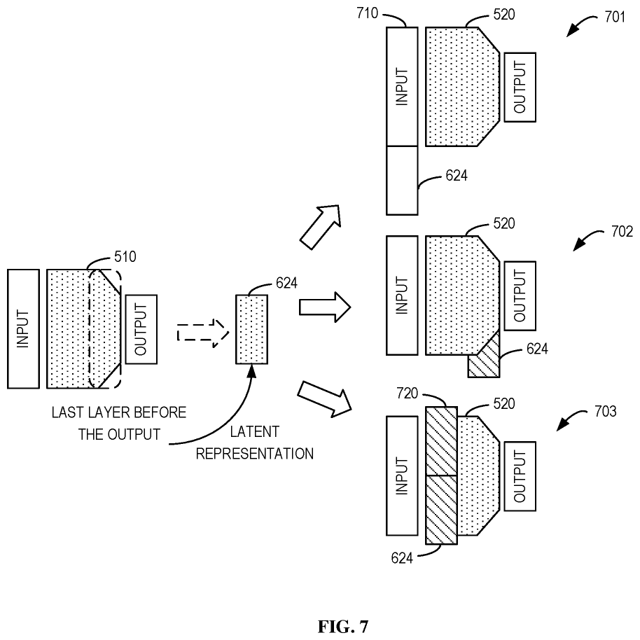

The latent representation 624 may be integrated into the machine learning model 520 in any suitable ways. FIG. 7 illustrates a schematic diagram showing some example integrations of the latent representation 624 from the machine learning model 510 with the machine learning model 520.

In an example integration 701, the latent representation 624 may be considered as additional input to the machine learning model 520. Thus, the latent representation 624 may be input together with a model input 710 (i.e., the information available at the network layer 120) into the machine learning model 520, to generate a predicted output. For example, the latent representation 624 may be concatenated with the model input 710 and then input together into the machine learning model 520.

In some embodiments, the latent representation 624 may be input to one or more hidden layers of the machine learning model 520. As such, the latent representation 624 may be processed together with the input of the one or more hidden layers, which may also be called a latent representation that is extracted by the machine learning model 520 from the input information available at the network layer 120. As such, the latent representation 624 and the native latent representation may be further processed by the following layers in the machine learning model 520.

In the embodiments of inputting to the hidden layer, in an example integration 701, the latent representation 624 may be input to the last layer before the output layer of the machine learning model 520, to affect the final prediction of the machine learning model 510. A latent representation extracted by the previous layers from the input of the machine learning model 510 may be processed together with the latent representation 624 in the last layer, to generate the predicted output. In an example integration 703, the latent representation 624 may be input to an earlier layer before the last layers, for example, the last one before a dense layer in the machine learning model 520. The latent representation 624 may thus be processed together with a latent representation 720 extracted by the previous layer(s) from the input of the machine learning model 520.

After the machine learning models 510 and 520 have been trained, the two models can be provided for execution by a network device, e.g., the network device 204 if the two models are trained in the context of serving cell selection, and the orchestrator 432 at the non-RT layer 430 (or the orchestrator 422 at the near-RT layer 420) in the context of resource allocation. It is noted that the example integration of the latent representation 624 is applied in both the model training phase and the model inference phase of the machine learning model 520.

### Example Model Training for Cell Selection

For the purpose of better illustration, the model training of the machine learning models 510 and 520 will be described in the context of serving cell selection. Similar model training process may be applied in the context of resource allocation in the O-RAN.

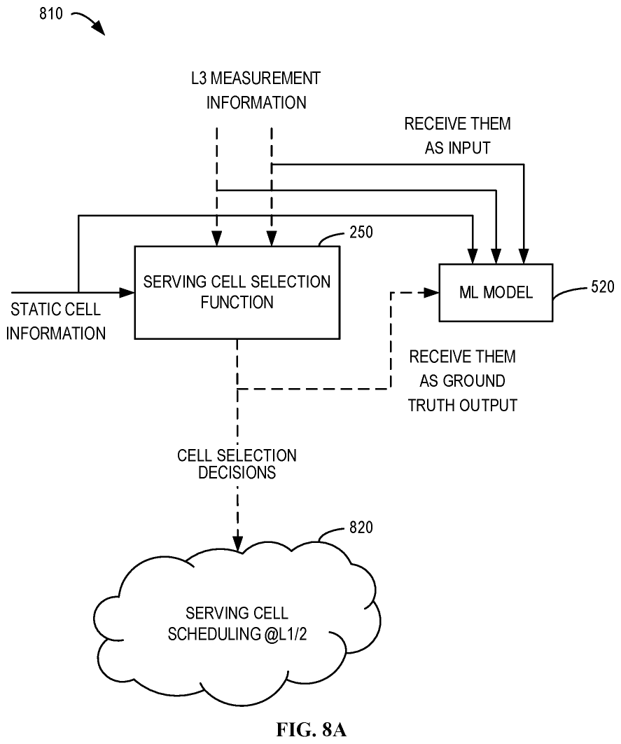

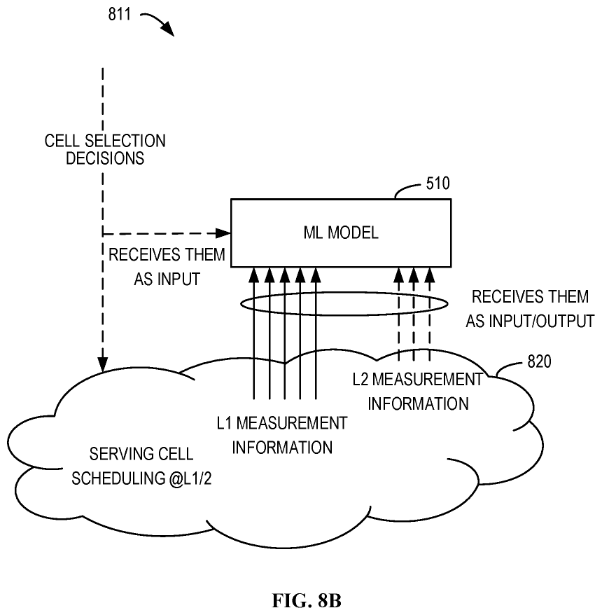

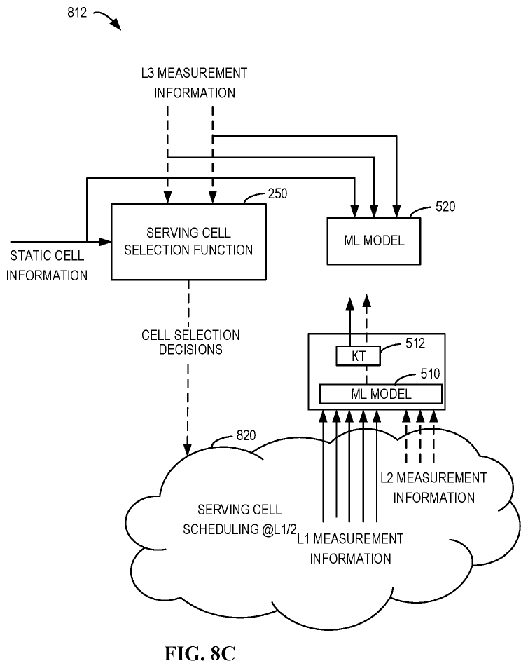

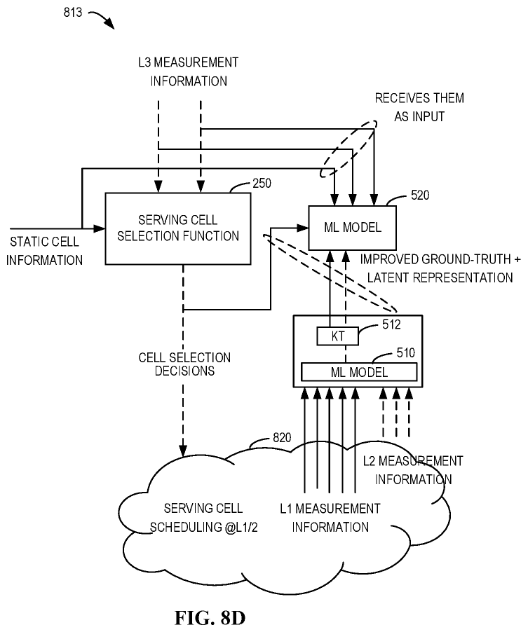

FIG. 8A to FIG. 8D illustrate schematic diagrams of different training stages for the machine learning models 510 and 520 with knowledge transfer in accordance with some embodiments of the present disclosure. In those embodiments, as mentioned, the machine learning model 520 is configured to perform a serving cell selection task at the L3 layer, and the machine learning model 510 is configured to perform a serving cell scheduling task at the L1/L2 layer.

An example 810 of FIG. 8A show an initial training phase (or a warm-up phase) of the machine learning model 520. The machine learning model 520 may be initially trained. To derive training data for the machine learning model 520, a legacy serving cell selection function, for example, the serving cell selection function 250 at the L3 layer, may be utilized. The input to the machine learning model 520 include measurement information that are available at the L3 layer, which is first input to the serving cell selection function 250. The serving cell selection function 250 may be designed in any suitable way (for example, based on expert knowledge) to perform the serving cell selection task based on the L3 measurement information and probably based on static cell information. The L3 measurement information may include, for example, network configuration (UL/DL cells, bandwidth, spectrum sharing, etc.), UE capabilities, and the like. The serving cell selection function 250 outputs its serving cell selection decisions to a serving cell scheduler at the L1/L2 layer 820 for serving cell scheduling. The inputs and outputs of the serving cell selection function 250 may be received as training data of the machine learning model 520, where the outputs are considered as ground truth outputs.

In FIG. 8A, the machine learning model 520 is trained at the L3 layer to learn the serving cell selection mechanism by taking as an input of the serving cell selection function 250 and outputting a selection of one or more potential serving cells for a certain terminal device. Note that other parameters can be added as input of the machine learning model 520 besides to static cell information and L3 measurement information. In some embodiments, the output of the machine learning model 520 may be a hard decision on the selected serving cell(s). In some embodiments, the output of the machine learning model 520 may be a soft vector of values between 0 and 1 which can be interpretated as the probability of each cell to be selected. For example, if the output vector length is 4, a hard decision output of [0, 1, 0, 0] may indicate that the cell number 2 is selected. If the output vector length is 4 a soft decision output of [0.1, 0.5, 0.3, 0.2] may indicate that the cell number 2 with the highest probability is selected.

In some embodiments, the machine learning model 520 may be initially trained using a supervised learning algorithm, e.g., a neural network (NN), which requires the output of the serving cell selection function 250 as ground truth outputs. Note that in this case the machine learning model may consist in a multi-label classifier, where each class represents a serving cell, and several classes can be selected simultaneously. In some embodiments, the machine learning model 520 may be initially trained using a semi-supervised ranking algorithm, which uses some labels and ranks from the outputs of the serving cell selection function 250 to help adapting the ground truth labels.

In some embodiments, the machine learning model 520 may be initially trained using an unsupervised learning algorithm (e.g. a clustering algorithm), which can be trained on historical data from L3 measurement information of different terminal devices (including the network configuration and UE capabilities) to define clusters, each cluster representing a serving cell. The label of the serving cell may be mapped to a cluster from the outputs of the serving cell selection function 250 and is used to help adapting the ground truth. Then, for new L3 measurement information for a terminal device, the algorithm can select the cluster(s) (and corresponding serving cell(s)) that are closest in terms of a distance, which are then passed to the L1/L2 scheduler. The unsupervised algorithm can incorporate information from Radio Parameters (DMRS, modulation, etc.) as well as from the current implementation in the product, which consists in a rule-based approach, especially for the definition of the distance between one measurement and a cluster. The choice of the unsupervised algorithm may depend on the distribution of the data and on the time constraint. For example, if the clusters are well separated and balanced (with approximately the same number of examples in each cluster), the K-means or density-based spatial clustering of applications with noise (DBSCAN) approach may be used. Otherwise, more advanced techniques such as spectral clustering or a neural network designed to both classify and learn rules can be used. Of course, any other suitable unsupervised learning algorithms may also be applicable.

An example 811 of FIG. 8B shows a training phase of the machine learning model 510. The machine learning model 510 is trained at the L1/L2 layer 820 to learn the serving cell scheduling mechanism. The input to the machine learning model 510 includes L1 measurement information and/or L2 measurement information at the L1/L2 layer 820, which may include, for example, RSRP, RSRQ, signal to interference plus noise ratio (SINR), CA/categories, buffer status record, channel rank, utilized MIMO, and/or the like. Further, the input to the machine learning model 510 also include a serving cell selection decision from the L3 layer. The serving cell scheduling task is to determine which selected serving cell(s) is to be scheduled and activated for the terminal device. In some embodiments, with the machine learning model 520 initially trained, the input serving cell decisions may be provided from the initially trained machine learning model 520. In some embodiments, the input serving cell decisions may be provided from the serving cell selection function 250.

The output of the machine learning model 510 may thus indicate at least one serving cell to be scheduled for the terminal device, for example, a pCell and possible sCell(s) to be scheduled. In some embodiments, this output may be determined as a vector of values between 0 and 1 which can be interpretated as the probability of each cell to be scheduled. This output may be used for scheduling if the machine learning model 510 replaces the legacy serving cell scheduler. As an alternative, this output may be provided as a recommendation to the serving cell scheduler. Further, a latent representation of the input information extracted by the machine learning model 510 may be transferred to the L3 layer for the machine learning model 520. In some embodiments, the latent representation may be compressed in time, for example, as a two-dimensional (2D) array of size (L, n), where L is the size of the latent representation and n is the number of time instances within a period of time in the input.

In some embodiments, the machine learning model 510 may be trained using a supervised learning algorithm, e.g. a neural network (NN), which requires the output of the legacy serving cell scheduler at the L1/L2 layer as ground truth outputs. In this case, the latent representation may be the last layer before classifying the selected serving cells. The benefits in such a representation is that it reduces the three-dimensional (3D) input size (d, t, n) of the machine learning model 510, where d is the number of input features to the model, t is the size of time frame, and n is the number of time instances to be considered for training or taking a decision, to a 2D array of size (L, n), where L is the output size of the last hidden layer. This leads to an important dimensionality reduction since L is typically much lower than the original input size, i.e., L<<d*t. In some embodiments, the machine learning model 510 may apply a dimensionality reduction technique, such as a projection on a manifold. However, using a supervised neural network should be more effective as it proposes a latent representation that is adapted to the task of scheduling and selection serving cells.

The main purpose of training the machine learning model 510 is to transfer information from the L1/L2 layer to the L3 layer, that would be useful to enhance the decision of the L3 serving cell selection while reducing the cross-layer signaling overhead, the memory and time consumption added from this transfer of information. Note that the input to the machine learning model 510 does not need to be transferred here, as its information is summarized by the latent representation.

In some embodiments the machine learning model 510 is trained with data from several terminal devices in the network spread across several serving cells, and therefore information from non-selected cells can still be obtained from these other terminal devices and the ML algorithm can adapt to unseen conditions. The training process from different terminal devices and different cells can result in good stability and optimality of the cell selection/scheduling as the decision for one terminal device can be enhanced by information from a different but similar terminal device.

An example 812 of FIG. 8C shows that the trained machine learning model 510 and the KT function 512 prepare the inference from the L1/L2 measurement information for the L3 layer. An example 813 of FIG. 8D shows (re)training of the machine learning model leveraging the latent representation transferred from the L1/L2 layer. In this phase, the machine learning model 520 may be trained using a supervised learning algorithm (e.g., a neural network) by integrating the latent representation from the L1/L2 layer to enrich the feature space. The integration of the latent representation into the machine learning model 520 may refer to the ABOVE description related to FIG. 7. In some embodiments, the integration is to simply concatenate the latent representation from the machine learning model 510 with the desired layer of the machine learning model 520. The values of the latent representation are frozen, only the weights to and from these values of the latent representation need to be trained with backpropagation during the training. If the latent representation is concatenated with the input of the machine learning model 520 (as in the example integration 701), then only the weights from the latent representation need to be trained.

In some embodiments, the ground truth outputs at the L3 layer may be modified in order to improve the ground truths for the machine learning model 520 with the integration of the latent representation because the original ground truths at the L3 layer may be derived by the legacy serving cell selection function. In this case, for a certain terminal device, the ground truth output at the L3 layer (indicating which serving cell to be selected) and the ground truth output at the L1/L2 layer (indicating which serving cell to be scheduled) may be aggregated to generate a new aggregated ground truth output for the terminal device (which is sometimes referred to as a third ground truth output). The aggregated ground truth output indicates whether the at least one serving cell is to be selected as a potential serving cell for the terminal device within the period of time. The aggregated ground truth output is then used to train the machine learning model 520. As shown in FIG. 8D, ground-truth outputs are received from the L1/L2 layer to improve the ground-truth outputs at the L3 layer for use in training the machine learning model 530. Typically, if a selected serving cell is actually scheduled for the terminal device, this cell may be considered as an optimal cell for the terminal device. With the ground-truth outputs from the L1/L2 layer, better ground truths in the serving cell selection may be used to guide the learning of the model at the L3 layer.

In some embodiments, the aggregation may consider the difference in time granularity in both the L1/L2 layer and the L3 layer, so that the result is consistent with the time granularity at the L3 layer. The ground truth output at the L1/L2 layer may indicate whether at least one serving cell is to be scheduled for a terminal device at multiple time instances within a period of time, while the ground truth output at the L3 layer may indicate one serving cell decision for that period of time. The ground truth aggregation may include averaging the initial L3 ground truth output with a weighted average of the L1/L2 ground truth output. In some embodiments, the weights for each L1/L2 ground truth output are uniform and accounts for 50% of the final ground truth output. In some embodiments, the L1 ground truth can be summarized with a majority vote, which consists in the cell that was most activated during the considered period of time. Note that the ground truth aggregation may similarly applied to the resource allocation in the O-RAN.

In some cases, the scheduling of the “best” serving cell(s) in the Layer 1/2 is conditioned on the pre-selected cells from the initially-trained machine learning model 520 at the L3 layer, which is performed to avoid delay due to computational time and/or need for resources but might result in the selection of cells that are not best suited to the terminal devices compared to what could be selected if the L1 and L3 input information were computed on all the available serving cells in the network. In some embodiments, multi-source multi-target transferring is proposed, to mimic the L1/L2 scheduling mechanism if it could make the measurements on all the available serving cells, not just the selected ones.

In order to complete the overall information about different cells in L3 (or respectively in L1/L2), it is proposed to use multi-source muti-target domain adaptation between one or more pre-selected serving cells (which have available measurement information) to one or more non-selected serving cells (without measurement information for transfer to the L3 layer). The multi-source muti-target domain adaptation may be performed either at the L1/L2 layer or at the L3 layer, to estimate what would be the latent representation of the non-measured serving cells.

The idea here is to train a small machine learning model 510 per cell in the L 1/2 layer. Each machine learning model 510 may be considered as specific to a corresponding serving cell. Every machine learning model 510 has information related to a specific serving cell as its input and outputs whether the corresponding serving cell is selected or not. In some embodiments, the machine learning models 510 for different serving cells may have the same model architecture to simplify the learning, although different model architectures may also be applicable. Then a transfer of one or more layers from these trained machine learning models 510 to the L3 layer is conducted to make the L3 layer more aware about the decision and the measurements at the L1/L2 layer.

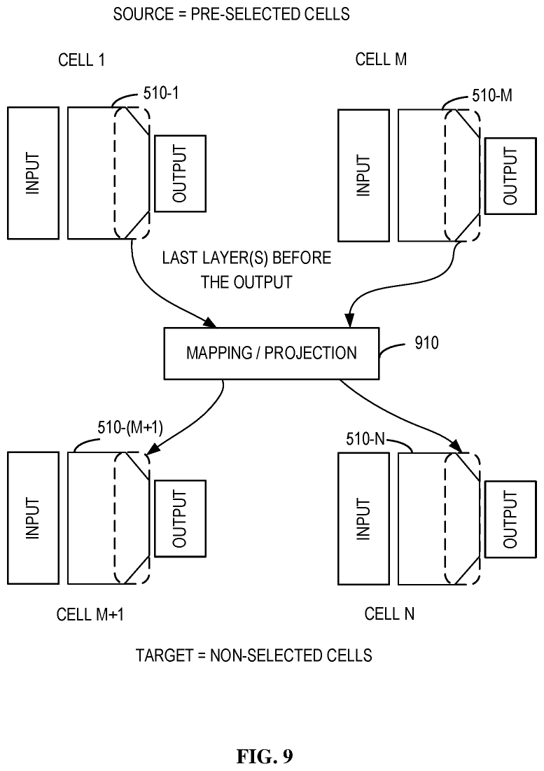

FIG. 9 illustrates a schematic diagram showing domain adaptation between pre-selected cells and non-selected cells in accordance with some embodiments of the present disclosure. As shown, a machine learning model 510-1 in the L1/2 layer is configured specifically for Cell 1, and a machine learning model 510-m in the L1/2 layer is configured specifically for Cell m. Cell 1 and Cell m are serving cells that have been pre-selected by the initially trained machine learning model 520 for a certain terminal device and thus the machine learning model 510-1, . . . 510-m can be trained (in a similar way to what is shown in FIG. 8B) using available measurement information. Cell m+1 and cell N are serving cells that have not been selected, and thus no measurement information related to those cells can be obtained to transfer to the L3 layer. It is noted that each of the machine learning models 510-1, . . . , 510-m, 510-(m+1), . . . , 510-N may operate in a similar way to the machine learning model 510 executed at the L3 layer as discussed above. In some embodiments, the machine learning models 510-1, . . . 510-m, 510-(m+1), . . . , 510-N may be configured as smaller models or neural networks because each of them corresponds to a single serving cell. Of course, the output layer of those models thus consists in a single neuron which outputs a soft value between 0 and 1 to select a serving cell based on its measurement information. The associated latent representation is thus specific to a serving cell. The size of the latent representation L′ may be lower than the one as discussed above for the machine learning model 510, but the information to transfer to the L3 layer may thus be L′ times the number of the pre-selected cells.

During the whole model training process, the multi-source muti-target domain adaptation between pre-selected cells and non-selected cells may be applied after one or more machine learning models 510 that are specific to certain serving cells have been trained (as in FIG. 8B) and before the machine learning model 520 is trained (as in FIG. 8C). A mapping or projection function 910 is proposed for the domain adaption from a source domain (e.g., where Cell 1, . . . Cell m are located) to a target domain (e.g., where Cell m+1, . . . Cell N are located). The latent representations for the non-selected serving cells (Cell m+1, . . . Cell N) are unavailable because the measurement information related to those cells are not available. The mapping or projection function 910 is configured to estimate the latent representations for the non-selected serving cells (e.g., Cell m+1, . . . Cell N) from the latent representations for the pre-selected serving cell (e.g., Cell 1, . . . Cell m). As illustrated in FIG. 9, the mapping or projection function 910 takes the data from the pre-selected cells, Cell 1, . . . Cell m, as the source domains and aims at mapping or projecting them on the non-selected ones, Cell m+1, . . . Cell N, considered as different targets.

To be more specific, latent representations of available measurement information (which may be extracted by the trained machine learning models 510-1,. 510-m) may be mapped or projected to generate latent representations for the non-selected serving cells. The estimated latent representations for the non-selected serving cells may then be provided to train the machine learning model 520 at the L3 layer. In this way, the machine learning model 520 can also learn knowledge about the non-selected serving cell.

In some embodiments, the multi-source muti-target domain adaptation may be performed at the L1/L2 layer, and the estimated latent representations may be provided to the L3 layer. Both the latent representations for the pre-selected serving cells and the estimated latent representations for the non-selected serving cells are transferred to the L3 layer. As an alternative, in some embodiments, the multi-source muti-target domain adaptation may be performed at the L3 layer after the latent representations for the pre-selected serving cells are received from the L1/L2 layer. In the latter case, some additional information from network configuration and UE capabilities at the L3 layer may be additionally utilized to implement the domain adaptation. It is noted that the choice between the two options of multi-source muti-target domain adaptation depends on the computational capacities at the L1/L2 layer and the overhead required to send all the latent representations from the L1/L2 layer to the L3 layer. The latter option reduces the overhead.

In some embodiments, if a machine learning model 520 for the L3 layer is initially trained, the same machine learning model 520 as the one in the initial training may be retrained using the latent representations, L3 measurement information, and corresponding ground truth outputs. In some embodiments, the machine learning model 520 for use at the L3 layer may be different from the initially trained machine learning model and can be trained from scratch or can be warm started from the initially trained machine learning model.

### Example Signaling of Model Training for Cell Selection

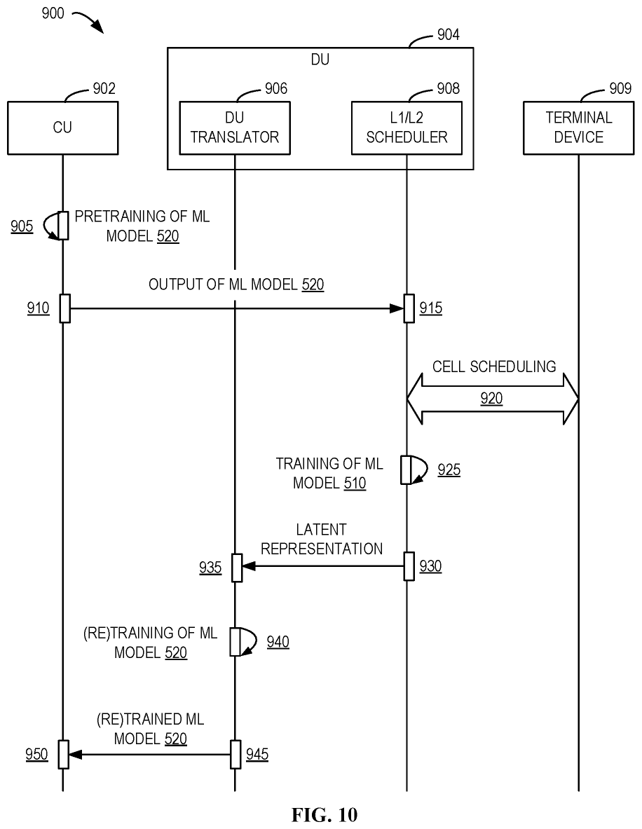

FIG. 10 illustrates a signaling chart 1000 for training of machine learning models with knowledge transfer in accordance with some further embodiments of the present disclosure. In the illustrated embodiments, it is assumed that the training of machine learning models is implemented at a network device with a centralized unit (CU) 902 and a distributed unit (DU) 904. The CU 902 is corresponding to the L3 layer. The DU 904 comprises a DU translator to interface with the CU 902 and a L1/L2 scheduler for serving cell scheduling at the L1/L2 layer. It would be appreciated that the signaling chart 1000 provides one example of training of machine learning models proposed herein. As mentioned, the training of machine learning models may be implemented in other ways.

In the signaling chart 1000, the CU 902 performs (905) pretraining of the machine learning model 520, and transmits (910) output of the initially trained machine learning model 520 to the L1/L2 scheduler 908. The output of the initially trained machine learning model 520 indicates if one or more serving cells are pre-selected for a terminal device 909. By receiving (915) the output of the initially trained machine learning model 520, the L1/L2 scheduler 908 performs (920) cell scheduling for the terminal device 909, for example, to schedule one or more pre-selected serving cell for the terminal device 909.

The scheduling result may be collected as a ground truth output to train (925) the machine learning model 510 at the L1/L2 scheduler 908. The training data for the machine learning model 510 may further include L1/L2 measurement information available at the L1/L2 layer. After the training, the trained machine learning model 510 is used to extract a latent representation of the L1/L2 measurement information at the L1/L2 scheduler 908. The L1/L2 scheduler 908 transfers (930) the latent representation to the DU translator 906. In some embodiments, the L1/L2 ground truth output may also be transferred to the DU translator 906. By receiving (935) required information, the DU translator 906 performs (940) (re)training of the machine learning model 520. In some embodiments, the L1/L2 ground truth output may be aggregated with the L3 ground truth output to generate an aggregated ground truth output for training. The retrained machine learning model 520 is provided (945) to the CU 902. By receiving (950) the trained machine learning model 520, the CU 920 can implement serving cell selection using this model.

The training of machine learning models for resource allocation in the use case of O-RAN may be similar to that discussed above in the use case of serving cell selection.

### Example Model Inference

After the machine learning models are trained and ready to use, the model inference may be similar and the steps are the same, except for the fact that it does not require the ground truth outputs. At the model inference phase, the inputs and outputs of the machine learning models 510 and 520 are similar to those discussed above. The latent representation is transferred from the trained machine learning model 510 to the machine learning model 520.

In some cases, as mentioned, the analytic task 112 is related to the analytic task 122, for example, based on an output of the analytic task 122. In this case, at the model inference phase, an initialization step is needed, to allow the machine learning model 510 to first extract a latent representation for use by the second machine learning model. The initialization step may be performed either by the legacy network function for the analytic task 122 in the network layer 120, or by the machine learning model 520. The output of the analytic task 122 is provided from the network layer 120 to the network layer 110. The trained machine learning model 510 may generate the predicted output for the analytic task 112 based on the input information and a predicted output of the analytic task 122.

For example, in the RAN 200, a serving cell pre-selection procedure is performed at a time step t−1 by the trained machine learning model 520. Afterwards, the pre-selection in the L3 layer is based on the output at time t−1 and updated at time t with the L1/L2 knowledge transfer.

More specifically, as an initialization step, the trained machine learning model 520 may be first used to generate, at the network layer 120, a predicted output for the analytic task 122 based on information available at the network layer 120. The predicted output is transmitted to the network layer 110 as a part of the model input of the trained machine learning model 510. As such, the trained machine learning model 510 can have a complete input to extract the latent representation for transferring to the network layer 120.

In some embodiments, considering the multi-source muti-target domain adaptation in the use case of serving cell selection, if a trained machine learning model 510 is specific for a first serving cell, and the first latent representation is specific to the first serving cell, and if measurement information related to a second serving cell is unavailable, then the first latent representation of the first measurement information related to the first serving cell may be mapped at the L3 layer to a third latent representation for the second serving cell. As an alternative, the third latent representation for the second serving cell may be estimated at the L1/L2 layer based on the first latent representation for the first serving cell and transferred to the L3 layer. With the third latent representation for the second serving cell as a part of its model input, the machine learning model 520 can generate the predicted output to indicate whether the second serving cell is to be selected as a potential serving cell for the terminal device.

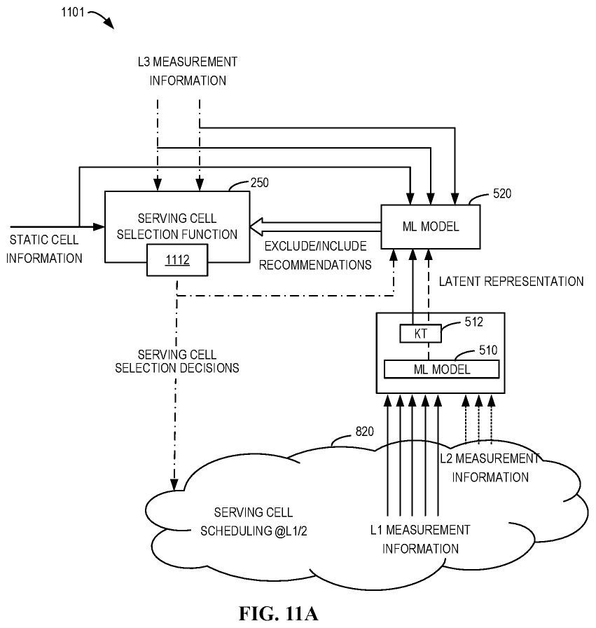

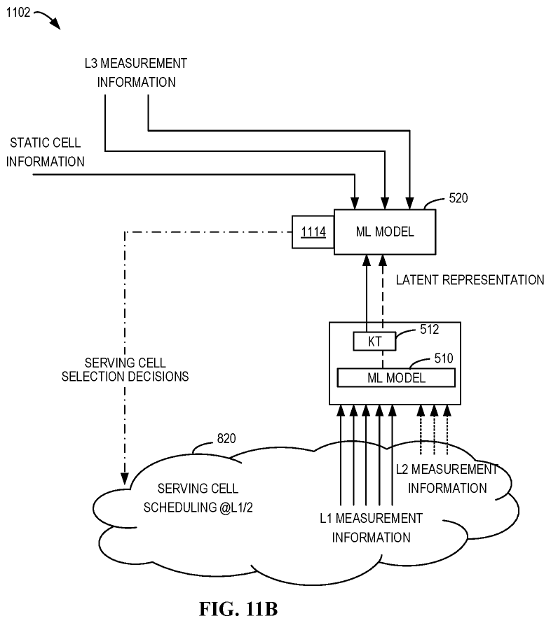

In some embodiments, as mentioned above, the predicted output from the machine learning model 520 may be provided as a recommendation for determining the target output, or may be directly determined as the target output. FIG. 11A and FIG. 11B illustrate schematic diagrams of inference of machine learning models with knowledge transfer in the use case of serving cell selection.

In an example 1101 of FIG. 11A, the serving cell selection function 250 is applied at the L3 layer, with a decision provider 1112 to provide serving cell selection decisions for cell scheduling at the L1/L2 layer 820. The trained machine learning model 510 at the L1/L2 layer extracts a latent representation of the L1/L2 measurement information and transfers the latent representation to the machine learning model at the L3 layer via the KT function 512. The machine learning model 520 may generate a predicted output about whether one or more serving cells are to be selected for a terminal device and provide the predicted output as a recommendation to the serving cell selection function 250. The serving cell selection function 250 may generate the serving cell selection decision based on legacy input such as the static cell information, L3 measurement information and the recommendation from the machine learning model 520. In this example, the recommendation from the machine learning model 520 may be easily excluded or included in the decision making for the serving cell selection.

In an example 1102 of FIG. 11B, the machine learning model 520 is used in replace of the serving cell selection function 250 at the L3 layer. The input to the machine learning model 520 may include the L3 measurement information, the latent representation from the L1/L2 layer, and possible static cell information. A decision provider 1114 is configured to provide a predicted output of the machine learning model 520 as a serving cell selection decision for cell scheduling at the L1/L2 layer 820.

The deployment and usage of the machine learning models 510 and 520 may be determined according to actual requirements which is not limited in the scope of the present disclosure.

### Example Methods

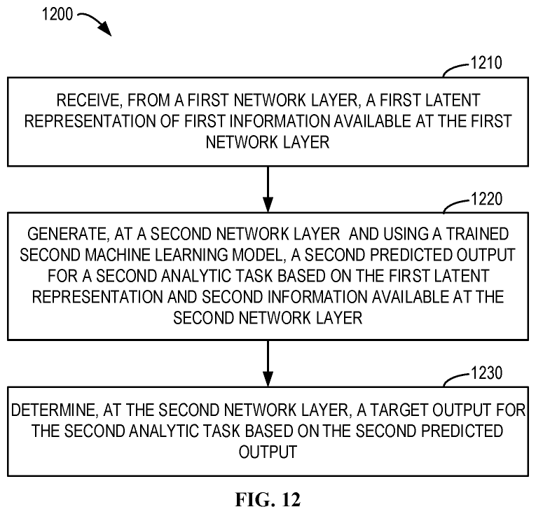

FIG. 12 illustrates a flowchart of a method 1200 implemented at a network device in accordance with some embodiments of the present disclosure. The method 1200 may be implemented at the network device 204 in FIG. 2 and/or the orchestrator 432 or 422 in FIG. 4.

At block 1210, a first latent representation of first information is received at a second network layer and from a first network layer. The first information is available at the first network layer. The first latent representation is extracted by a trained first machine learning model executed at the first network layer, and the first machine learning model is configured to generate a first predicted output for a first analytic task based on the first information. The second network layer is different from the first network layer.

At block 1220, a second predicted output for a second analytic task is generated using a trained second machine learning model at the second network layer based on the first latent representation and second information available at the second network layer.

In some embodiments, the first latent representation is input together with the second information into the second machine learning model. In some embodiments, the first latent representation is processed together with a second latent representation of the second information by the second machine learning model to generate the second predicted output.

In some embodiments, the first analytic task is based on an output of the second analytic task. In some embodiments, a third predicted output for the second analytic task is generated at the second network layer based on third information available at the second network layer. In some embodiments, the first machine learning model is configured to generate the first predicted output for the first analytic task based on the first information and the third predicted output.

At block 1230, a target output for the second analytic task is determined at the second network layer based on the second predicted output. In some embodiments, the second predicted output is provided as a recommendation for determining the target output, or is determined as the target output.

In some use cases, the first predicted output indicates whether at least one serving cell is to be scheduled for a terminal device, the second predicted output indicates whether the at least one serving cell is to be selected as a potential serving cell for the terminal device, and the target output indicates a subset of serving cells selected from a set of available serving cells for the terminal device. In those use cases, in some embodiments, the first network layer comprises a lower protocol layer, and the second network layer comprises a higher protocol layer. In some embodiments, the first information comprises first measurement information related to the at least one serving cell at the lower protocol layer, and the second information comprises second measurement information related to the at least one serving cell at the higher protocol layer.

In some embodiments, the first machine learning model is trained for a first serving cell, and the first latent representation is specific to the first serving cell. In some embodiments, in accordance with a determination that measurement information related to a second serving cell is unavailable, the first latent representation of the first measurement information related to the first serving cell is mapped at the higher protocol layer to a third latent representation for the second serving cell. In some embodiments, the third latent representation for the second serving cell is received at the higher protocol layer from the lower protocol layer.

In some embodiments, the second predicted output is generated further based on the third latent representation, to further indicate whether the second serving cell is to be selected as a potential serving cell for the terminal device.

In some use cases, the first predicted output indicates resource allocation to at least one terminal device located in a network slice, the second predicted output indicates potential resource allocation to a traffic flow in the network slice, and the target output indicates target resource allocation to the traffic flow in the network slice. In those use cases, in some embodiments, the first network layer comprises a real time layer in an open radio access network (O-RAN), and the second network layer comprises a non-real time layer or a near real time layer in the O-RAN. In those use cases, in some embodiments, the first network layer comprises a near-real time layer in the O-RAN, and the second network layer comprises a non-real time layer in the O-RAN.

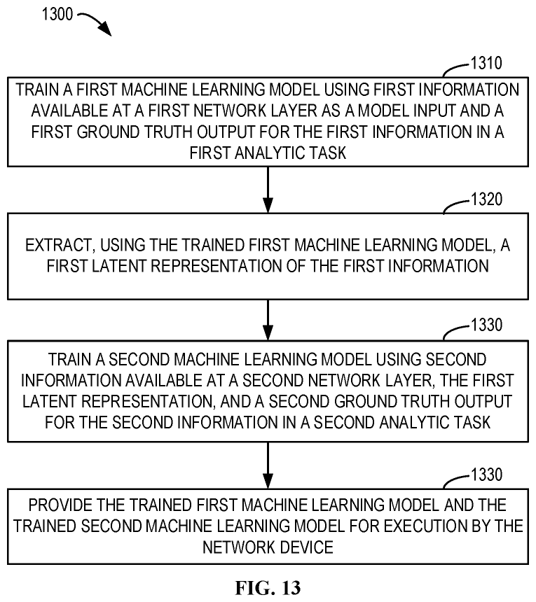

FIG. 13 illustrates a flowchart of a method for model training in accordance with some embodiments of the present disclosure. The method 1300 may be implemented at the network device 204 in FIG. 2, the orchestrator 432 or 422 in FIG. 4, or an external computing system/device, such as a virtualization system 1500 of FIG. 15.

At block 1310, a first machine learning model is trained using first information available at a first network layer as a model input and a first ground truth output for the first information in a first analytic task. At block 1320, a first latent representation of the first information is extracted using the trained first machine learning model. At block 1330, a second machine learning model is trained using second information available at a second network layer, the first latent representation, and a second ground truth output for the second information in a second analytic task. At block 1340, the trained first machine learning model and the trained second machine learning model are provided for execution by the network device.

In some embodiments, the first latent representation is input together with the second information into the second machine learning model. In some embodiments, the first latent representation is processed together with a second latent representation of the second information by the second machine learning model to generate a model output.

In some embodiments, before the training of the first machine learning model, initial training of the second machine learning model is performed using at least third information available at the second network layer. In those embodiments, the second machine learning model is retrained using the second information, the first latent representation, and the second ground truth output.

In some use cases, the first ground truth output indicates whether at least one serving cell is to be scheduled for a terminal device, and the second ground truth output indicates whether the at least one serving cell is to be selected as a potential serving cell for the terminal device. In some embodiments, the first information comprises first measurement information related to the at least one serving cell at the lower protocol layer, and the second information comprises second measurement information related to the at least one serving cell at the higher protocol layer.

In some embodiments, the first ground truth output is retrieved from a serving cell scheduler at the lower protocol layer and indicates whether the at least one serving cell is to be scheduled for the terminal device. In some embodiments, the second ground truth output is retrieved from a serving cell selection function at the higher protocol layer and indicates whether the at least one serving cell is to be selected as a potential serving cell for the terminal device.

In some embodiments, the first ground truth output indicates whether the at least one serving cell is to be scheduled for the terminal device at respective time instances within a period of time. In some embodiments, the first ground truth output and the second ground truth output are aggregated to obtain an aggregated ground truth output indicating whether the at least one serving cell is to be selected as a potential serving cell for the terminal device within the period of time. In some embodiments, the second machine learning model is trained using the aggregated ground truth output.

In some embodiments, the first machine learning model is trained for a first serving cell, and the first latent representation is specific to the first serving cell. In those embodiments, in accordance with a determination that measurement information related to a second serving cell is unavailable, the first latent representation of the first measurement information related to the first serving cell is mapped to a third latent representation for the second serving cell. In some embodiments, the second machine learning model is trained further using the third latent representation.

In some use cases, the first ground truth output indicates resource allocation to at least one terminal device located in a network slice, and the second ground truth output indicates potential resource allocation to a traffic flow in the network slice. In those use cases, the first network layer comprises a lower protocol layer, and the second network layer comprises a higher protocol layer. In those use cases, in some embodiments, the first network layer comprises a real time layer in an open radio access network (O-RAN), and the second network layer comprises a non-real time layer or a near real time layer in the O-RAN. In some embodiments, the first network layer comprises a near-real time layer in the O-RAN, and the second network layer comprises a non-real time layer in the O-RAN.

### Example Device/System

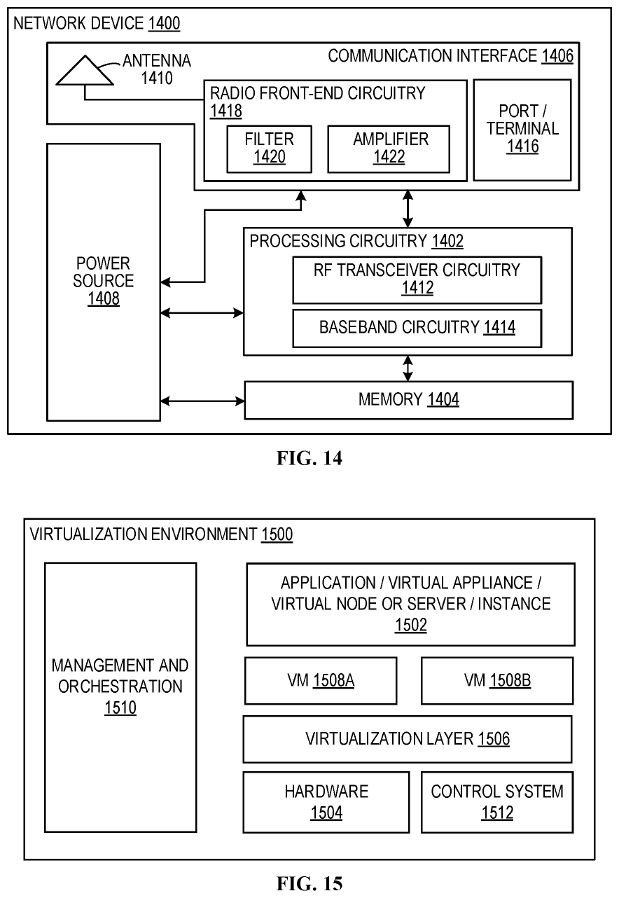

FIG. 14 illustrates a simplified block diagram of a network device 1400 that is suitable for implementing embodiments of the present disclosure. As used herein, network device refers to equipment capable, configured, arranged and/or operable to communicate directly or indirectly with a terminal device and/or with other network devices or equipment, in a telecommunication network. Examples of network devices include, but are not limited to, access points (APs) (e.g., radio access points), base stations (BSs) (e.g., radio base stations, Node Bs, evolved Node Bs (eNBs) and NR NodeBs (gNBs)). In some embodiments of the present disclosure, the FSF 210 and/or the model provider 110 as discussed above may be implemented as or included in the network device 1400.

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network device may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network devices include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network device 1400 includes a processing circuitry (including a processor(s)) 1402, a memory 1404, a communication interface 1406, and a power source 1408. The network device 1400 may be composed of multiple physically separate components (e.g., a NodeB component and a RNC component, or a BTS component and a BSC component, etc.), which may each have their own respective components. In certain scenarios in which the network device 1400 comprises multiple separate components (e.g., BTS and BSC components), one or more of the separate components may be shared among several network devices. For example, a single RNC may control multiple NodeBs. In such a scenario, each unique NodeB and RNC pair, may in some instances be considered a single separate network device. In some embodiments, the network device 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network device 1400 may also include multiple sets of the various illustrated components for different wireless technologies integrated into the network device 1400, for example GSM, WCDMA, LTE, NR, Wi-Fi, Zigbee, Z-wave, LoRaWAN, Radio Frequency Identification (RFID) or Bluetooth wireless technologies. These wireless technologies may be integrated into the same or different chip or set of chips and other components within the network device 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network device 1400 components, such as the memory 1404, to provide network device 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network device 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network device, access network, and/or terminal device. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network devices or terminal devices via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network device 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network device 1400 and connectable to the network device 1400 through an interface or port.

The antenna 1410, communication interface 1406, and/or the processing circuitry 1402 may be configured to perform any receiving operations and/or certain obtaining operations described herein as being performed by the network device. Any information, data and/or signals may be received from a terminal device, another network device and/or any other network equipment. Similarly, the antenna 1410, the communication interface 1406, and/or the processing circuitry 1402 may be configured to perform any transmitting operations described herein as being performed by the network device. Any information, data and/or signals may be transmitted to a terminal device, another network device and/or any other network equipment.

The power source 1408 provides power to the various components of the network device 1400 in a form suitable for the respective components (e.g., at a voltage and current level needed for each respective component). The power source 1408 may further comprise, or be coupled to, power management circuitry to supply the components of the network device 1400 with power for performing the functionality described herein. For example, the network device 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network device 1400 may include additional components beyond those shown in FIG. 14 for providing certain aspects of the network device's functionality, including any of the functionality described herein and/or any functionality necessary to support the subject matter described herein. For example, the network device 1400 may include user interface equipment to allow input of information into the network device 1400 and to allow output of information from the network device 1400. This may allow a user to perform diagnostic, maintenance, repair, and other administrative functions for the network device 1400.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

In some example embodiments, an apparatus capable of performing any of the method 1200 (for example, the network device 204 in FIG. 2 and/or the orchestrator 432 or 422 in FIG. 4) may comprise means for performing the respective operations of the method 1200. The means may be implemented in any suitable form. For example, the means may be implemented in a circuitry or software module. The apparatus may be implemented as or included in the network device 204 and/or the orchestrator 432 or 422.

In some example embodiments, the apparatus comprises means for receiving, from a first network layer, a first latent representation of first information available at the first network layer, the first latent representation being extracted by a trained first machine learning model executed at the first network layer, the first machine learning model being configured to generate a first predicted output for a first analytic task based on the first information; means for generating, at a second network layer and using a trained second machine learning model, a second predicted output for a second analytic task based on the first latent representation and second information available at the second network layer, the second network layer being different from the first network layer; and means for determining, at the second network layer, a target output for the second analytic task based on the second predicted output, wherein the first predicted output indicates whether at least one serving cell is to be scheduled for a terminal device, the second predicted output indicates whether the at least one serving cell is to be selected as a potential serving cell for the terminal device, and the target output indicates a subset of serving cells selected from a set of available serving cells for the terminal device, or wherein the first predicted output indicates resource allocation to at least one terminal device located in a network slice, the second predicted output indicates potential resource allocation to a traffic flow in the network slice, and the target output indicates target resource allocation to the traffic flow in the network slice. In some example embodiments, the second predicted output is provided as a recommendation for determining the target output, or is determined as the target output.

In some example embodiments, the first latent representation is input together with the second information into the second machine learning model. In some example embodiments, the first latent representation is processed together with a second latent representation of the second information by the second machine learning model to generate the second predicted output.

In some example embodiments, the first analytic task is based on an output of the second analytic task, the apparatus further comprises: means for generating, at the second network layer, a third predicted output for the second analytic task based on third information available at the second network layer. In some example embodiments, the first machine learning model is configured to generate the first predicted output for the first analytic task based on the first information and the third predicted output.

In some example embodiments, the first network layer comprises a lower protocol layer, and the second network layer comprises a higher protocol layer. In some example embodiments, the first information comprises first measurement information related to the at least one serving cell at the lower protocol layer, and the second information comprises second measurement information related to the at least one serving cell at the higher protocol layer.

In some example embodiments, the first machine learning model is trained for a first serving cell, and the first latent representation is specific to the first serving cell, the apparatus further comprises: means for, in accordance with a determination that measurement information related to a second serving cell is unavailable, mapping, at the higher protocol layer, the first latent representation of the first measurement information related to the first serving cell to a third latent representation for the second serving cell; or means for receiving, at the higher protocol layer, the third latent representation for the second serving cell from the lower protocol layer.

In some example embodiments, the second predicted output is generated further based on the third latent representation, to further indicate whether the second serving cell is to be selected as a potential serving cell for the terminal device.

In some example embodiments, the first network layer comprises a real time layer in an open radio access network (O-RAN), and the second network layer comprises a non-real time layer or a near real time layer in the O-RAN. In some example embodiments, the first network layer comprises a near-real time layer in the O-RAN, and the second network layer comprises a non-real time layer in the O-RAN.

In some example embodiments, the apparatus further comprises means for performing other operations in some example embodiments of the method 1200. In some example embodiments, the means comprises at least one processor; and at least one memory storing instructions that, when executed by the at least one processor, cause the performance of the apparatus.

In some embodiments, an apparatus capable of performing any of the method 1300 (for example, the network device 204 in FIG. 2, the orchestrator 432 or 422 in FIG. 4, or an external device/computing system, such as the virtualization system 1500) may comprise means for performing the respective operations of the method 1300. The means may be implemented in any suitable form. For example, the means may be implemented in a circuitry or software module. The apparatus may be implemented as or included in the network device 204 in FIG. 2, the orchestrator 432 or 422 in FIG. 4, or an external computing system/device, such as the virtualization system 1500.

In some embodiments, the apparatus comprises means for training a first machine learning model using first information available at a first network layer as a model input and a first ground truth output for the first information in a first analytic task; means for extracting, using the trained first machine learning model, a first latent representation of the first information; means for training a second machine learning model using second information available at a second network layer, the first latent representation, and a second ground truth output for the second information in a second analytic task; and means for providing the trained first machine learning model and the trained second machine learning model for execution by the network device, wherein the first ground truth output indicates whether at least one serving cell is to be scheduled for a terminal device, and the second ground truth output indicates whether the at least one serving cell is to be selected as a potential serving cell for the terminal device, or wherein the first ground truth output indicates resource allocation to at least one terminal device located in a network slice, and the second ground truth output indicates potential resource allocation to a traffic flow in the network slice.

In some example embodiments, the first latent representation is input together with the second information into the second machine learning model. In some example embodiments, the first latent representation is processed together with a second latent representation of the second information by the second machine learning model to generate a model output.

In some example embodiments, the apparatus further comprises means for, before the training of the first machine learning model, performing initial training of the second machine learning model using at least third information available at the second network layer. In some example embodiments, the second machine learning model is retrained using the second information, the first latent representation, and the second ground truth output.

In some example embodiments, the first network layer comprises a lower protocol layer, and the second network layer comprises a higher protocol layer. In some example embodiments, the first information comprises first measurement information related to the at least one serving cell at the lower protocol layer, and the second information comprises second measurement information related to the at least one serving cell at the higher protocol layer.

In some example embodiments, the first ground truth output is retrieved from a serving cell scheduler at the lower protocol layer and indicates whether the at least one serving cell is to be scheduled for the terminal device. In some example embodiments, the second ground truth output is retrieved from a serving cell selection function at the higher protocol layer and indicates whether the at least one serving cell is to be selected as a potential serving cell for the terminal device.

In some example embodiments, the first ground truth output indicates whether the at least one serving cell is to be scheduled for the terminal device at respective time instances within a period of time, the apparatus further comprising: means for aggregating the first ground truth output and the second ground truth output to obtain an aggregated ground truth output indicating whether the at least one serving cell is to be selected as a potential serving cell for the terminal device within the period of time, In some example embodiments, the second machine learning model is trained using the aggregated ground truth output.

In some example embodiments, the first machine learning model is trained for a first serving cell, and the first latent representation is specific to the first serving cell, the apparatus further comprising: means for, in accordance with a determination that measurement information related to a second serving cell is unavailable, mapping the first latent representation of the first measurement information related to the first serving cell to a third latent representation for the second serving cell. In some example embodiments, the second machine learning model is trained further using the third latent representation.

In some example embodiments, the first network layer comprises a real time layer in an open radio access network (O-RAN), and the second network layer comprises a non-real time layer or a near real time layer in the O-RAN. In some example embodiments, the first network layer comprises a near-real time layer in the O-RAN, and the second network layer comprises a non-real time layer in the O-RAN.

In some example embodiments, the apparatus further comprises means for performing other operations in some example embodiments of the method 1300. In some example embodiments, the means comprises at least one processor; and at least one memory storing instructions that, when executed by the at least one processor, cause the performance of the apparatus.

In some embodiments, a computer readable storage medium having instructions stored thereon is provided. The instructions when executed by at least one processor can cause the at least one processor to carry out the functionality in accordance with any one of the embodiments described herein. In some embodiments, the computer readable medium may be a non-transitory computer readable storage medium. A computer readable storage medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a read-only memory (ROM), a random-access memory (RAM), an erasable programmable read-only memory (EPROM or Flash memory), an optical fiber, a portable compact disc read-only memory (CD-ROM), an optical storage device, a magnetic storage device, or any suitable combination of the foregoing.

In some embodiments, a computer program comprising instructions is provided. The instructions, when executed by at least one processor, cause the at least one processor to carry out the functionality in accordance with any one of the embodiments described herein. In one embodiment, a carrier containing the aforementioned computer program product is provided. The carrier is one of an electronic signal, an optical signal, a radio signal, or a computer-readable storage medium (e.g., a non-transitory computer-readable medium).

Although the computing devices described herein (e.g., network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, RAM, cache memory, flash memory devices, optical storage devices, etc. Program code stored in memory includes program instructions for executing one or more telecommunications and/or data communications protocols as well as instructions for carrying out one or more of the techniques described herein. In some embodiments, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method implemented by a network device, comprising:
receiving, from a first network layer, a first latent representation of first information available at the first network layer, the first latent representation being extracted by a trained first machine learning model executed at the first network layer, the first machine learning model being configured to generate a first predicted output for a first analytic task based on the first information;
generating, at a second network layer and using a trained second machine learning model, a second predicted output for a second analytic task based on the first latent representation and second information available at the second network layer, the second network layer being different from the first network layer; and
determining, at the second network layer, a target output for the second analytic task based on the second predicted output,
wherein the first predicted output indicates whether at least one serving cell is to be scheduled for a terminal device, the second predicted output indicates whether the at least one serving cell is to be selected as a potential serving cell for the terminal device, and the target output indicates a subset of serving cells selected from a set of available serving cells for the terminal device, or
wherein the first predicted output indicates resource allocation to at least one terminal device located in a network slice, the second predicted output indicates potential resource allocation to a traffic flow in the network slice, and the target output indicates target resource allocation to the traffic flow in the network slice.

2. The method according to claim 1, wherein the first latent representation is input together with the second information into the second machine learning model; or
wherein the first latent representation is processed together with a second latent representation of the second information by the second machine learning model to generate the second predicted output.

3. The method according to claim 1, wherein the first analytic task is based on an output of the second analytic task, the method further comprising:
generating, at the second network layer, a third predicted output for the second analytic task based on third information available at the second network layer; and
wherein the first machine learning model is configured to generate the first predicted output for the first analytic task based on the first information and the third predicted output.

4. The method according to claim 1, wherein the first network layer, comprises a lower protocol layer, and the second network layer comprises a higher protocol layer, and
wherein the first information comprises first measurement information related to the at least one serving cell at the lower protocol layer, and the second information comprises second measurement information related to the at least one serving cell at the higher protocol layer.

5. The method according to claim 4, wherein the first machine learning model is trained for a first serving cell, and the first latent representation is specific to the first serving cell, the method further comprising:
in accordance with a determination that measurement information related to a second serving cell is unavailable, mapping, at the higher protocol layer, the first latent representation of the first measurement information related to the first serving cell to a third latent representation for the second serving cell; or
receiving, at the higher protocol layer, the third latent representation for the second serving cell from the lower protocol layer.

6. The method according to claim 5, wherein the second predicted output is generated further based on the third latent representation, to further indicate whether the second serving cell is to be selected as a potential serving cell for the terminal device.

7. The method according to claim 1, wherein the first network layer comprises a real time layer in an open radio access network (O-RAN), and the second network layer comprises a non-real time layer or a near real time layer in the O-RAN; or
wherein the first network layer comprises a near-real time layer in the O-RAN, and the second network layer comprises a non-real time layer in the O-RAN.

8. The method according to claim 1, wherein the second predicted output is provided as a recommendation for determining the target output, or is determined as the target output.

9. A method for training machine learning models to be executed by a network device, the method comprising:
training a first machine learning model using first information available at a first network layer as a model input and a first ground truth output for the first information in a first analytic task;
extracting, using the trained first machine learning model, a first latent representation of the first information;
training a second machine learning model using second information available at a second network layer, the first latent representation, and a second ground truth output for the second information in a second analytic task; and
providing the trained first machine learning model and the trained second machine learning model for execution by the network device,
wherein the first ground truth output indicates whether at least one serving cell is to be scheduled for a terminal device, and the second ground truth output indicates whether the at least one serving cell is to be selected as a potential serving cell for the terminal device, or
wherein the first ground truth output indicates resource allocation to at least one terminal device located in a network slice, and the second ground truth output indicates potential resource allocation to a traffic flow in the network slice.

10. The method according to claim 9, wherein the first latent representation is input together with the second information into the second machine learning model; or
wherein the first latent representation is processed together with a second latent representation of the second information by the second machine learning model to generate a model output.

11. The method according to claim 9, further comprising:
before the training of the first machine learning model, performing initial training of the second machine learning model using at least third information available at the second network layer; and
wherein the second machine learning model retrained using the second information, the first latent representation, and the second ground truth output.

12. The method according to claim 9, wherein the first network layer comprises a lower protocol layer, and the second network layer comprises a higher protocol layer, and
wherein the first information comprises first measurement information related to the at least one serving cell at the lower protocol layer, and the second information comprises second measurement information related to the at least one serving cell at the higher protocol layer.

13. The method according to claim 12, wherein the first ground truth output is retrieved from a serving cell scheduler at the lower protocol layer, and
wherein the second ground truth output is retrieved from a serving cell selection function at the higher protocol layer.

14. The method according to claim 12, wherein the first ground truth output indicates whether the at least one serving cell is to be scheduled for the terminal device at respective time instances within a period of time, the method further comprising:
aggregating the first ground truth output and the second ground truth output to obtain an aggregated ground truth output indicating whether the at least one serving cell is to be selected as a potential serving cell for the terminal device within the period of time; and
wherein the second machine learning model is trained using the aggregated ground truth output.

15. The method according to claim 12, wherein the first machine learning model is trained for a first serving cell, and the first latent representation is specific to the first serving cell, the method further comprising:
in accordance with a determination that measurement information related to a second serving cell is unavailable, mapping the first latent representation of the first measurement information related to the first serving cell to a third latent representation for the second serving cell; and
wherein the second machine learning model is trained further using the third latent representation.

16. The method according to claim 9, wherein the first network layer comprises a real time layer in an open radio access network (O-RAN), and the second network layer comprises a non-real time layer or a near real time layer in the O-RAN; or
wherein the first network layer comprises a near-real time layer in the O-RAN, and the second network layer comprises a non-real time layer in the O-RAN.

17. A network device comprising:
at least one processor; and
at least one memory coupled to the at least one processor, the at least one memory comprising instructions that when executed by the at least one processor implement a method comprising:
receiving, from a first network layer, a first latent representation of first information available at the first network layer, the first latent representation being extracted by a trained first machine learning model executed at the first network layer, the first machine learning model being configured to generate a first predicted output for a first analytic task based on the first information;
generating, at a second network layer and using a trained second machine learning model, a second predicted output for a second analytic task based on the first latent representation and second information available at the second network layer, the second network layer being different from the first network layer; and
determining, at the second network layer, a target output for the second analytic task based on the second predicted output,
wherein the first predicted output indicates whether at least one serving cell is to be scheduled for a terminal device, the second predicted output indicates whether the at least one serving cell is to be selected as a potential serving cell for the terminal device, and the target output indicates a subset of serving cells selected from a set of available serving cells for the terminal device, or
wherein the first predicted output indicates resource allocation to at least one terminal device located in a network slice, the second predicted output indicates potential resource allocation to a traffic flow in the network slice, and the target output indicates target resource allocation to the traffic flow in the network slice.

18. A computing system comprising:
at least one processor; and
at least one memory coupled to the at least one processor, the at least one memory comprising instructions that when executed by the at least one processor implement a method for training machine learning models to be executed by a network device, the method comprising:
training a first machine learning model using first information available at a first network layer as a model input and a first ground truth output for the first information in a first analytic task;
extracting, using the trained first machine learning model, a first latent representation of the first information;
training a second machine learning model using second information available at a second network layer, the first latent representation, and a second ground truth output for the second information in a second analytic task; and
providing the trained first machine learning model and the trained second machine learning model for execution by the network device,
wherein the first ground truth output indicates whether at least one serving cell is to be scheduled for a terminal device, and the second ground truth output indicates whether the at least one serving cell is to be selected as a potential serving cell for the terminal device, or
wherein the first ground truth output indicates resource allocation to at least one terminal device located in a network slice, and the second ground truth output indicates potential resource allocation to a traffic flow in the network slice.

19-20. (canceled)
